(19) United States
(12) Patent Application Publication
(10) Pub. No.: US 2012/0113772 A1
(43) Pub. Date: May 10, 2012

(54) INFORMATION RECORDING MEDIUM, OPTICAL INFORMATION RECORDING AND REPRODUCING APPARATUS, OPTICAL INFORMATION RECORDING AND REPRODUCING METHOD AND MANUFACTURING METHOD OF INFORMATION RECORDING MEDIUM

(76) Inventors: Teruhiro Shiono, Osaka (JP); Noboru Yamada, Osaka (JP)

(21) Appl. No.: 13/384,891

(22) PCT Filed: Jul. 20, 2010
(86) PCT No.: PCT/JP2010/004649

§ 371 Date: Jan. 19, 2012

(30) Foreign Application Priority Data
Jul. 21, 2009 (JP) 2009-170141
Aug. 4, 2009 (JP) 2009-181842

(51) Int. Cl. G11B 13/04; G11B 7/1374; B05D 5/06; G11B 7/26

(52) U.S. Cl. 369/13.33; 720/718; 427/162; G9B/7.121; G9B/7.194; G9B/13.004

(57) ABSTRACT

To provide an information recording medium which is capable of reducing damage to a recording layer while improving environmental resistance of the recording layer and which enables information to be recorded or reproduced at a high density and a high sensitivity, an optical information recording and reproducing apparatus, an optical information recording and reproducing method, and a manufacturing method of an information recording medium. An information recording medium (24) includes: a substrate (1); first to m^{th} (where m is an integer equal to or greater than 1) recording layers (2) respectively provided on an incident side of recording light or reproducing light with respect to the substrate (1) in order of distance closer to the incident side; and first to m^{th} (where m is an integer equal to or greater than 1) negative refractive index layers (3) respectively provided on the incident side of the recording light or the reproducing light with respect to the m^{th} recording layer (2) in order of distance closer to the incident side, wherein an i^{th} (1≦i≦m) recording layer (2) and an i^{th} negative refractive index layer (3) are alternately provided on the substrate (1), and the first to m^{th} negative refractive index layers (3) effectively have a negative refractive index at a wavelength of the recording light or the reproducing light.

### TECHNICAL FIELD

The present invention relates to an information recording medium for recording or reproducing information, an optical information recording and reproducing apparatus, an optical information recording and reproducing method, and a manufacturing method of an information recording medium. In particular, the present invention relates to an information recording medium for recording or reproducing information at a high sensitivity and a high density using near-field light, an optical information recording and reproducing apparatus, an optical information recording and reproducing method, and a manufacturing method of an information recording medium.

### BACKGROUND ART

Optical memory systems using an optical disk such as a compact disc (CD), a DVD, and a BD (Blu-Ray disc) or an optical card and the like as an information recording medium are being put to practical use as optical information recording and reproducing apparatuses.

In order to achieve even greater amounts of recordable information, an apparatus that performs high-density optical recording using near-field light that enables formation of minute spots equal to or smaller than a diffraction limit of light, and an information recording medium for the apparatus have been proposed (for example, refer to Patent Literature 1 and Patent Literature 2).

FIG. 17 is an explanatory diagram showing recording of information on a conventional information recording medium. As shown in FIG. 17, a conventional information recording medium comprises, on a substrate 101, a recording layer 102 which is made of a phase-change recording material such as GeTe—Sb₂Te₃ and on which recorded marks 104 are arranged (in FIG. 17, an array period is set to A₁₀₀).

A conventional optical information recording and reproducing apparatus uses a metal film having a triangle shape on an XY plane parallel to the substrate 101 (since FIG. 17 is a cross-sectional view, the triangle shape is not shown) as a near-field light generating element 105 in an optical head, irradiates the near-field light generating element 105 with linearly-polarized laser light 106 in a Y-axis direction to induce a surface plasmon resonance in the metal film, and generates a near-field light spot 107a at which light intensity is significantly increased compared to an incident light intensity (the near-field light spot 107a is referred to as a hotspot) in a vicinity of a tip of the metal film. The conventional optical information recording and reproducing apparatus irradiates the near-field light spot 107a onto a recording layer 102 arranged proximal to the near-field light generating element 105, causes a phase change (from crystalline to amorphous or from amorphous to crystalline) of the recording layer 102 to form recorded marks 104, and records or reproduces information based on units of the recorded marks 104.

FIG. 18 is an explanatory diagram showing recording of information on a different conventional information recording medium. The different conventional information recording medium shown in FIG. 18 comprises a protective film 109 provided on top of recorded marks 104 made of a phase-change recording material. Since a recording material including a phase-change recording material is generally susceptible to property degradation under environmental conditions such as high temperature and high humidity, providing the protective film 109 enables enhancement of environmental resistance and stabilizing of recording conditions.

However, the near-field light used by the optical recording/reproducing apparatus and the near-field optical head in Patent Literature 1 and Patent Literature 2 is also referred to as evanescent light and is localized in an immediate vicinity of the near-field light generating element 105. The further away from the near-field light spot 107a, an intensity of near-field light attenuates exponentially and, at the same time, a spot diameter increases abruptly and the near-field light becomes blurry.

Attempting to record or reproduce information over a distance at which degradation of optical properties are less likely to occur by reducing a working distance (WD) that is an interval between the near-field light generating element 105 in an optical head and recorded marks 104 as an air gap increases a risk of the near-field light generating element 105 colliding with or coming into contact with the recorded marks 104 and may cause damage and degradation to both the near-field light generating element 105 and the recording layer 102.

On the other hand, increasing the WD in order to prevent collisions creates a risk of reducing near-field light intensity on the recorded marks 104 of the recording layer 102 and, in turn, may significantly reduce recording sensitivity. For example, if a diameter of a hotspot is approximately 10 nm and the WD is set to 10 nm, typically, a light intensity of the near-field light spot 107b drops down to approximately 1/10 of a light intensity of the hotspot. At the same time, a spot diameter also increases abruptly, making it difficult to record or reproduce information at a high sensitivity and a high density. Referring to FIG. 17, for example, when the WD is set to 10 nm, typically, a diameter of the near-field light spot 107b increases to approximately 10 times the diameter of the hotspot. The present inventors have discovered problems such as described above.

In addition, providing a protective film 109 in order to improve environmental resistance of the recorded marks 104 of a phase-change recording material has a problem in that a WD that is an air gap between the protective film 109 and the near-field light generating element 105 as shown in FIG. 18 is further reduced.

### CITATION LIST

### Patent Literature

Patent Literature 1: Japanese Patent Application Laid-Open No. 2001-255254
Patent Literature 2: WO 2007/111304

### SUMMARY OF INVENTION

The present invention has been made in order to solve the problems described above, and an object thereof is to provide an information recording medium which is capable of reducing damage to a recording layer while improving environmental resistance of the recording layer and which enables information to be recorded or reproduced at a high density and a high sensitivity, an optical information recording and reproducing apparatus, an optical information recording and reproducing method, and a manufacturing method of an information recording medium.

An information recording medium according to an aspect of the present invention comprises: a substrate; first to m^{th} (where m is an integer equal to or greater than 1) recording layers respectively provided on an incident side of recording light or reproducing light with respect to the substrate, in order of distance closer to the incident side; and first to m^{th} (where m is an integer equal to or greater than 1) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately provided on the substrate, and the first to m^{th} negative refractive index layers effectively have a negative refractive index at a wavelength of the recording light or the reproducing light.

According to the present invention, a structure is realized in which a recording layer formed on a substrate is covered by a negative refractive index layer, and the negative refractive index layer protects the recording layer to enable damage to the recording layer to be reduced even if an information recording medium and an optical head collide with or come into contact with each other and to enable environmental resistance of the recording layer to be improved. As a result, a highly-reliable information recording medium can be realized.

In addition, the negative refractive index layer can generate a near-field light spot, which has a light intensity and a spot diameter that are more or less comparable to those of a near-field light spot as a hotspot occurring in a vicinity of a near-field light outputting element, on the recording layer while securing, to a certain extent, a working distance that is an interval between the optical head and a surface of the information recording medium. Therefore, the near-field light spot on the recording layer has a sensitivity and a resolution comparable to a case where recording or reproducing is performed by a hotspot, and enables information to be recorded or reproduced at a high density and a high sensitivity.

The objects, features, and advantages of the present invention will become more fully apparent as the following detailed description is read in light of the attached drawings.

### BRIEF DESCRIPTION OF DRAWINGS

FIG. 1 is a plan view showing a configuration of an information recording medium according to a first embodiment of the present invention.

FIG. 2 is a cross-sectional view taken along II-II in FIG. 1 showing a configuration of an information recording medium according to the first embodiment of the present invention.

FIG. 3 is an explanatory diagram showing a near-field light generating element of an optical information recording and reproducing apparatus, and recording information on or reproducing information from an information recording medium, according to the first embodiment of the present invention.

FIG. 4 is an explanatory diagram showing a configuration of an optical information recording and reproducing apparatus, and recording information on or reproducing information from an information recording medium, according to the first embodiment of the present invention.

FIG. 5 is a graph showing a variation in |electric field amplitude|² of near-field light in a Z-axis direction in an optical information recording and reproducing apparatus and an information recording medium according to the first embodiment of the present invention.

FIG. 6 is a graph showing a relationship between a normalized working distance in an optical information recording and reproducing apparatus and a refractive index of a negative refractive index layer in an information recording medium according to the first embodiment of the present invention.

FIG. 7 is an explanatory diagram showing a configuration of an optical information recording and reproducing apparatus, and recording information on or reproducing information from an information recording medium, according to a second embodiment of the present invention.

FIG. 8 is a graph showing a variation in |electric field amplitude|² of near-field light in a Z-axis direction in an optical information recording and reproducing apparatus and an information recording medium according to the second embodiment of the present invention.

FIG. 9 is an explanatory diagram showing a part of a configuration of an optical information recording and reproducing apparatus, and recording information on or reproducing information from an information recording medium, according to a third embodiment of the present invention.

FIG. 10 is an explanatory diagram showing a part of a configuration of an optical information recording and reproducing apparatus, and recording information on or reproducing information from an information recording medium, according to a fourth embodiment of the present invention.

FIG. 11 is an explanatory diagram showing a part of a configuration of an optical information recording and reproducing apparatus, and recording information on or reproducing information from a recording layer closest to an incident side (first layer) of an information recording medium, according to a fifth embodiment of the present invention.

FIG. 12 is an explanatory diagram showing a part of a configuration of an optical information recording and reproducing apparatus, and recording information on or reproducing information from a second closest recording layer to an incident side (second layer) of an information recording medium, according to the fifth embodiment of the present invention.

FIG. 13 is an explanatory diagram showing a part of a configuration of an optical information recording and reproducing apparatus, and recording information on or reproducing information from a recording layer closest to an incident side (first layer) of an information recording medium, according to a sixth embodiment of the present invention.

FIG. 14 is an explanatory diagram showing a part of a configuration of an optical information recording and reproducing apparatus, and recording information on or reproducing information from a second closest recording layer to an incident side (second layer) of an information recording medium, according to the sixth embodiment of the present invention.

FIG. 15 is an explanatory diagram showing a part of a configuration of an optical information recording and reproducing apparatus, and recording information on or reproducing information from an information recording medium, according to a ninth embodiment of the present invention.

FIG. 16 is an explanatory diagram showing a part of a configuration of an optical information recording and reproducing apparatus, and recording information on or reproducing information from a recording layer closest to an incident side (first layer) of an information recording medium, according to a tenth embodiment of the present invention.

FIG. 17 is an explanatory diagram showing recording of information on a conventional information recording medium.

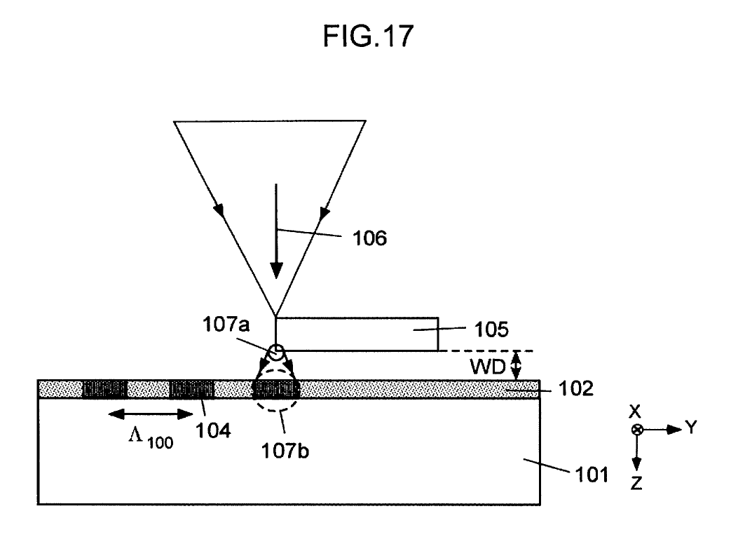

FIG. 18 is an explanatory diagram showing recording of information on a different conventional information recording medium.

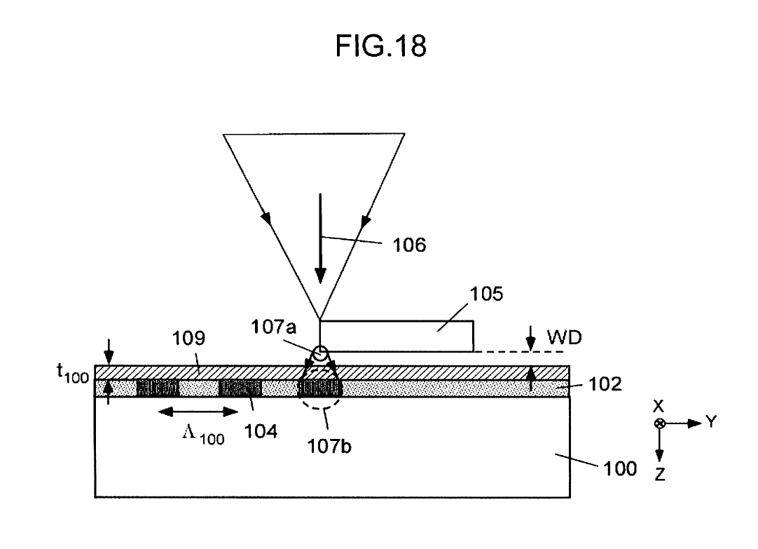

### DESCRIPTION OF EMBODIMENTS

Hereinafter, embodiments of the present invention will be described with reference to the drawings. The following embodiments merely illustrate examples of the present invention and are not intended to limit the technical scope of the present invention.

### First Embodiment

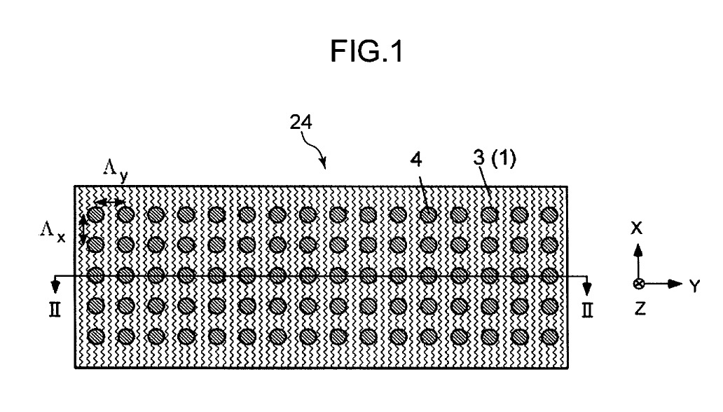

First, an information recording medium, an optical information recording and reproducing apparatus, and an optical information recording and reproducing method according to a first embodiment of the present invention will be described in detail with reference to FIGS. 1 to 6.

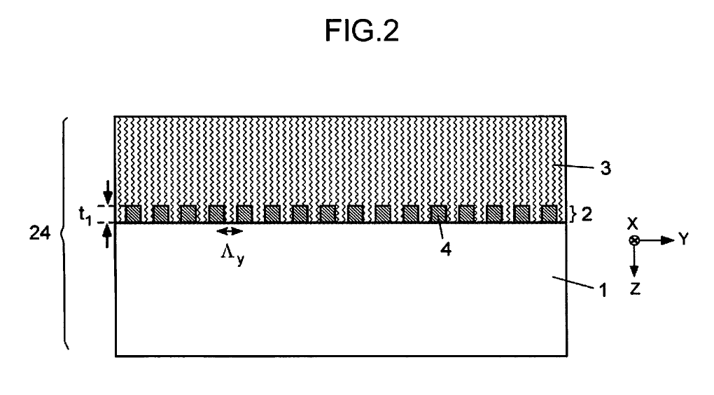

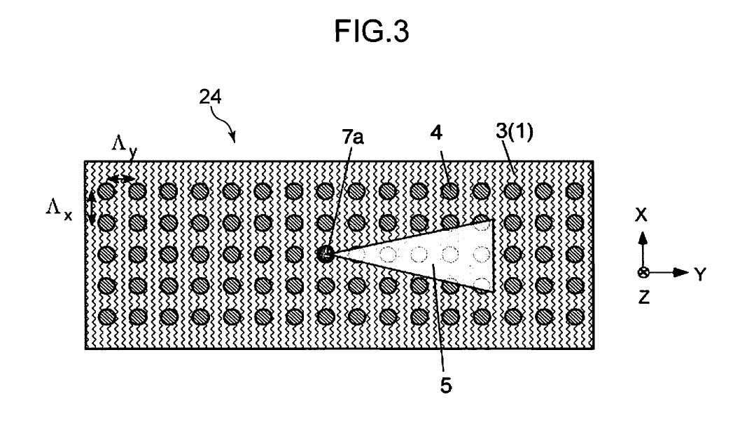

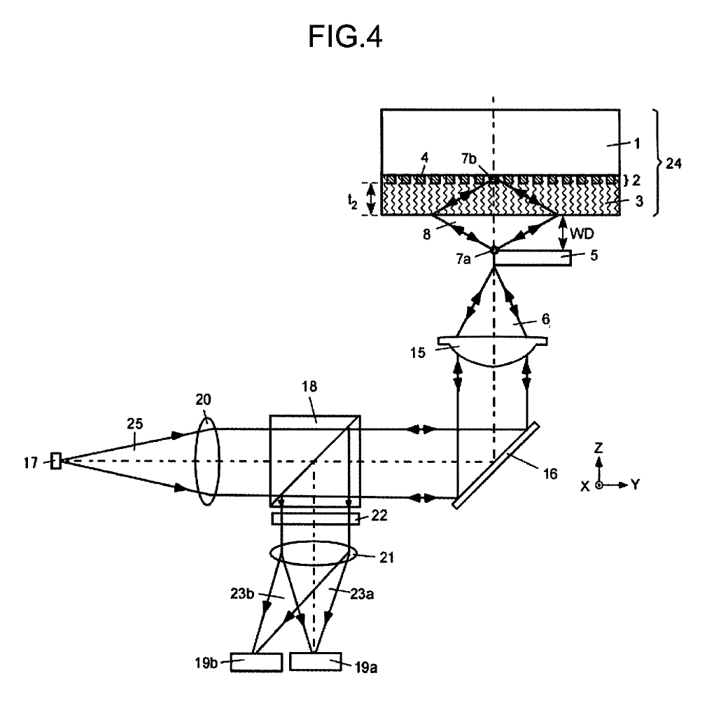

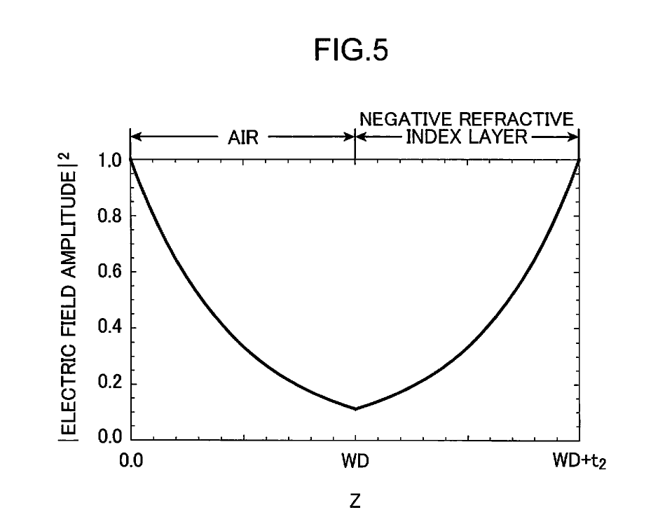

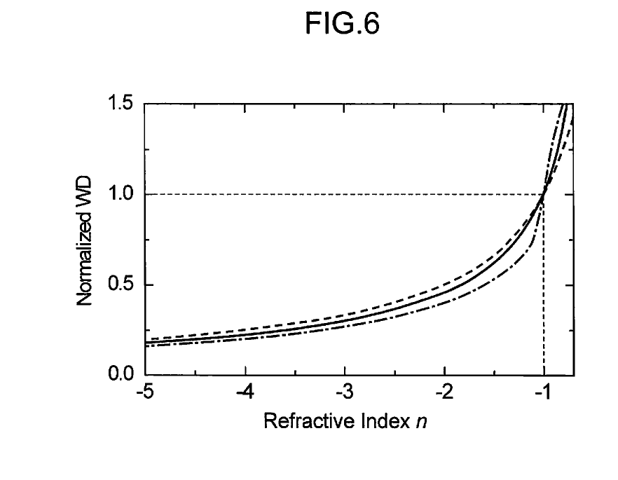

FIG. 1 is a plan view showing a configuration of an information recording medium according to the first embodiment of the present invention; FIG. 2 is a cross-sectional view taken along II-II in FIG. 1 showing a configuration of an information recording medium according to the first embodiment of the present invention; FIG. 3 is an explanatory diagram showing a near-field light generating element of an optical information recording and reproducing apparatus, and recording information on or reproducing information from an information recording medium, according to the first embodiment of the present invention; FIG. 4 is an explanatory diagram showing a configuration of an optical information recording and reproducing apparatus, and recording information on or reproducing information from an information recording medium, according to the first embodiment of the present invention; FIG. 5 is a graph showing a variation in |electric field amplitude|² of near-field light in a Z-axis direction in an optical information recording and reproducing apparatus and an information recording medium according to the first embodiment of the present invention; and FIG. 6 is a graph showing a relationship between a normalized working distance in an optical information recording and reproducing apparatus and a refractive index of a negative refractive index layer in an information recording medium according to the first embodiment of the present invention.

As shown in FIGS. 1 to 4, an information recording medium 24 according to the present invention at least comprises a negative refractive index layer 3 that effectively indicates a negative refractive index, a recording layer 2, and a substrate 1 which are provided in an order from an incident side of recording light or reproducing light (illustrated as near-field light 8 in FIG. 4). A structure is realized in which the recording layer 2 formed on the substrate 1 is covered by the negative refractive index layer 3, and the negative refractive index layer 3 becomes a protective film of the recording layer 2 which enables damage to the recording layer 2 to be reduced even if the information recording medium 24 collides or comes into contact with an optical head and which enables environmental resistance of the recording layer 2 to be improved. As a result, a highly-reliable information recording medium 24 can be realized.

As shown in FIG. 4, an optical information recording and reproducing apparatus according to the present embodiment records information on the recording layer 2 of the information recording medium 24 or reproduces information from the recording layer 2 of the information recording medium 24. The optical information recording and reproducing apparatus comprises: a light source 17 that outputs recording light or reproducing light 25; an objective lens 15; and a near-field light generating element 5 that generates near-field light. The objective lens 15 collects the recording light or the reproducing light 25 on the near-field light generating element 5. The optical information recording and reproducing apparatus uses at least a part of near-field light 8 generated by the near-field light generating element 5 to record information on the recording layer 2 of the information recording medium 24 or to reproduce information from the recording layer 2 of the information recording medium 24. Moreover, the near-field light generating element 5 according to the present embodiment corresponds to an example of a near-field light outputting element. In addition, a concept of near-field light as used in the present specification includes evanescent light.

An optical information recording and reproducing method according to the present embodiment records information on the recording layer 2 of the information recording medium 24 or reproduces information from the recording layer 2 of the information recording medium 24. The optical information recording and reproducing method comprises the steps of: outputting the recording light or the reproducing light 25 from the light source 17; generating the near-field light 8 from the near-field light generating element 5; collecting the recording light or the reproducing light 25 on the near-field light generating element 5 using the objective lens 15; and recording information on the recording layer 2 of the information recording medium 24 or reproducing information from the recording layer 2 of the information recording medium 24 using at least a part of the near-field light 8 generated from the near-field light generating element 5 as a result of the recording light or the reproducing light collected on the near-field light generating element by the objective lens.

The recording light or the reproducing light irradiated onto the information recording medium 24 includes the near-field light 8 that enables formation of a minute spot equal to or smaller than a diffraction limit of light, or all of the recording light or the reproducing light is near-field light. By recording information on the recording layer 2 of the information recording medium 24 or reproducing information from the recording layer 2 of the information recording medium 24 using at least a part of the near-field light 8 that has a high resolution, high density recording or reproducing of information can be realized.

The substrate 1 of the information recording medium 24 favorably has a high flatness in regards to a surface on which the recording layer 2 is formed and provides a high stability when the information recording medium 24 is rotated, and a glass substrate or a metal plate made of aluminum or the like, or a resin such as polycarbonate, PMMA, norbornene resin (for example, “ARTON” manufactured by JSR Corporation), and cycloolefin resin (for example, “ZEONEX” manufactured by ZEON Corporation) can be used.

When detecting a reproducing signal with reflected light as in the case of the optical information recording and reproducing apparatus according to the present embodiment (FIG. 4), for example, the substrate 1 can be constituted by a material that absorbs recording light or reproducing light by mixing resin with carbon or the like. In this case, unnecessary propagating light can be reduced to reduce stray light and an SN ratio of a detected signal can be enhanced. In addition, when a reproducing signal is detected with transmitted light, the substrate 1 may be constituted by a material with a high transparency in regards to the reproducing light.

The recording layer 2 may have a film geometry with a uniform thickness on an XY plane as long as the recording layer 2 includes a material with an optical constant that is variable when irradiated by a spot of the recording light (illustrated as a second near-field light spot 7b in FIG. 4). Alternatively, favorably, the recording layer 2 includes microparticles 4 which are arranged in a regular or quasi-regular island pattern (with an X-direction period of Λx, a Y-direction period of Λy, and a thickness of t₁) and which have an optical constant that is variable when irradiated by a spot of the recording light, wherein a size of the microparticles 4 in an array direction is favorably equal to or smaller than 30 nm.

In a case of a film geometry in which the recording layer 2 is continuously connected, heat is diffused into a phase-change recording material when heating necessary for crystallization of the phase-change recording material is performed by the near-field light. As a result, a large recorded mark exceeding 30 nm is recorded even if a spot of the near-field light is 30 nm. A difference in the sizes of recorded marks due to such thermal diffusion becomes prominent when the recorded marks are equal to or smaller than 30 nm. Therefore, when performing recording with recorded marks equal to or smaller than 30 nm, favorably, the microparticles 4 are isolated from each other and a size of the microparticles 4 in an array direction is set equal to or smaller than 30 nm.

However, when the phase-change recording material becomes smaller particles down to approximately 3 nm, the number of atoms included in a particle decreases. As a result, a melting point is excessively lowered and retention of recording on the phase-change recording material becomes unstable due to thermal fluctuation. In addition, regarding crystallization, the low melting point makes it difficult to slowly cool the phase-change recording material and inhibits crystallization, and destabilizes recording itself. Therefore, the sizes of the microparticles 4 in an array direction are favorably equal to or greater than 3 nm.

Moreover, in the present embodiment, the microparticles 4 refer to those processed in a minute convex shape such as shown in FIGS. 1 and 2. In addition to the circular cylindrical shape shown in FIGS. 1 and 2, the microparticles 4 may be shaped into a circular cone, a triangular prism, a triangular pyramid, a prism with four sides or more, or a pyramid with four sides or more.

By adopting a microparticle structure for the recording layer 2, since the respective microparticles are separated from each other, an influence of thermal diffusion during recording can be avoided and recording or reproducing of information at a high density of 30 nm or less can be achieved. In addition, a recording material such as an organic dye may be used as a major component of the microparticle 4. Alternatively, by using a phase-change recording material such as GeTe—Sb₂Te₃ as the major component of the microparticle 4, rewritable recording that enables high-quality recording, reproducing, and erasing can be performed.

Moreover, the major component of the microparticle 4 refers to a component with a maximum volume ratio among the constituents of the microparticle 4. Favorably, the major component of the microparticle 4 has a volume ratio of 50% or higher since a degree of modulation increases for reproducing. In addition, adopting a microparticle structure for the recording layer 2 has an advantageous effect of suppressing material diffusion between microparticles respectively during recording, reproducing, and erasing which is a degradation factor, thereby increasing the number of repetitions of recording, reproducing, and erasing.

Furthermore, all of the microparticles 4 need not be regularly arranged. Moreover, an array interval or an arrangement method of the microparticles 4 may be changed depending on the recorded information.

In addition, from the perspective of recording at higher densities, it is favorable to minimize the sizes of the microparticles 4 and provide isolated microparticles 4 as close to each other as possible. However, an excessively narrow interval between the respective microparticles 4 gives rise to the possibility that the respective microparticles 4 may come into contact with each other and the independence (isolated state) of the microparticles 4 can no longer be guaranteed. Therefore, the interval among the microparticles 4 is desirably designed by taking the above points into consideration.

The chalcogenide system is promising as the phase-change recording material. While the GeTe—Sb₂Te₃-base containing GeTe and Sb₂Te₃ at a ratio of 22:1 is used in the present embodiment, the ratio of the components may be altered. Alternatively, for example, materials including any of the following may also be used: the GeTe—Bi₂Te₃-base, Te₆₀Ge₄Sn₁₁Au₂₅, Ag₄In₄Sb₇₆Te₁₆, GeTe, (Ge—Sn)Te, (Ge—Sn)Te—Sb₂Te₃, (Ge—Sn)Te—Bi₂Te₃, GeTe—(Sb—Bi)₂Te₃, (Ge—Sn)Te—(Sb—Bi)₂Te₃, GeTe—(Bi—In)₂Te₃, (Ge—Sn)Te—(Bi—In)₂Te₃, Sb—Ga, (Sb—Te)—Ga, Sb—Ge, (Sb—Te)—Ge, Sb—In, (Sb—Te)—In, Sb—Mn—Ge, Sb—Sn—Ge, Sb—Mn—Sn—Ge, and (Sb—Te)—Ag—In.

A recording rate to the information recording medium 24 can be increased by using a phase-change recording material with a high crystallization speed such as (Ge—Sn)Te, GeTe—Bi₂Te₃, (Ge—Sn)Te—Bi₂Te₃, and Sb—Ge.

The negative refractive index layer 3 that effectively exhibits a negative refractive index at a wavelength of the recording light or the reproducing light is constituted by a metamaterial that is an artificially created structure, a photonic crystal, or the like, and is constituted by at least one of a metamaterial and a photonic crystal. A metamaterial can be produced through, for example, a three-dimensional self-assembly of a combination of a material such as a nanorod, a split ring resonator which is significantly smaller than a wavelength of the recording light or the reproducing light and which controls a behavior of an electromagnetic field, with a resin or a protein such as ferritin. A method of producing a metamaterial is described in “Plasmonic Metamaterials Produced by Two-photon-induced Photoreduction Technique” (Takuo Tanaka, JLMN-Journal of Laser Micro/Nanoengineering Vol. 3, No. 3, 2008, p. 152-156). A photonic crystal can be produced by forming a three-dimensional refractive index periodic structure using microfabrication technology. A photonic band structure is designed so as to exhibit a negative refractive index.

It is known that a material has a refractive index of exactly −1 when a relative permittivity of the material is −1 and a relative permeability of the material is −1. In this case, the negative refractive index layer 3 has a simple flat plate shape and exhibits a special lens effect that is known as a super lens effect or a perfect lens effect. In other words, a first near-field light spot 7a (FIG. 4) that is a hotspot generated by the near-field light generating element 5 is reproduced across a certain distance while maintaining an almost complete light intensity and resolution and without being restricted by a diffraction limit. In FIG. 4, the first near-field light spot 7a is reproduced as the second near-field light spot 7b.

Therefore, the negative refractive index layer 3 enables the second near-field light spot 7b having a light intensity and a spot diameter that are more or less comparable to those of the first near-field light spot 7a as a hotspot to be created on the recording layer 2 while securing a certain working distance (WD) that is an interval between the information recording medium 24 and the optical information recording and reproducing apparatus that is an optical head. Consequently, high density and high sensitivity recording and reproducing can be realized which have a sensitivity and a resolution that are comparable to a case in which information is recorded or reproduced with a hotspot.

In this case, the following two conditions must be confirmed in order to realize recording and reproducing that produce a super lens effect. The first condition is that, as indicated by a beam direction of the near-field light 8 shown in FIG. 4, when the near-field light 8 exiting the first near-field light spot 7a that is a hotspot incidents the negative refractive index layer 3, a direction of travel of the near-field light 8 in the XY plane is reversed and the near-field light 8 is collected as the second near-field light spot 7b on the microparticles 4 in the recording layer 2. If the negative refractive index layer 3 effectively exhibits a negative refractive index, known Snell's law dictates that the direction of travel in the XY plane is reversed. Therefore, by adjusting the WD that is an air gap between the near-field light generating element 5 and the negative refractive index layer 3, the first condition is satisfied. For example, if the refractive index n of the negative refractive index layer 3 is −1, then the WD may be set identical to a thickness t₂ of the negative refractive index layer 3 (WD=t₂).

The second condition is that squares of absolute values of an electric field amplitude (|electric field amplitude|²) of the first near-field light spot 7a and the second near-field light spot 7b are equal to or comparable to each other. As shown in FIG. 5, |electric field amplitude|² (in FIG. 5, |electric field amplitude|² of the first near-field light spot 7a has been normalized to 1.0) attenuates exponentially in air (a coordinate when a Z-position of the first near-field light spot 7a is assumed to be 0, where 0<Z<WD). On the other hand, if the negative refractive index layer 3 effectively exhibits a negative refractive index, |electric field amplitude|² is exponentially amplified in the negative refractive index layer 3 (WD≦Z≦WD+t₂). As a result, |electric field amplitude|² at the second near-field light spot 7b (Z=WD+t₂) has a same value (1.0) or a similar value to |electric field amplitude|² at the first near-field light spot 7a (Z=0). If the negative refractive index layer 3 effectively exhibits a negative refractive index, the second condition can also be satisfied by adjusting the WD between the near-field light generating element 5 and the negative refractive index layer 3.

Therefore, the first condition and the second condition are satisfied by adjusting the WD if the negative refractive index layer 3 effectively exhibits a negative refractive index, and recording and reproducing that produce a super lens effect can be achieved.

The present inventors have discovered that, while the negative refractive index layer 3 ideally has a refractive index n of −1 (n=−1), a negative refractive index layer 3 with a refractive index n equal to or smaller than −0.9 (n≦−0.9) is less likely to cause degradation of near-field light and can be used for recording and reproducing by adjusting the WD. For example, there may be a case in which even if a spot diameter of the second near-field light spot 7b degrades from a spot diameter of the first near-field light spot 7a that is a hotspot, if enough energy is irradiated onto the microparticles 4 which perform recording and reproducing, the actual recording and reproducing are not affected even if other proximal microparticles are irradiated to a certain degree (a crosstalk is generated).

The normalized WD shown in FIG. 6 is a normalization of the WD when the refractive index n of the negative refractive index layer 3 is −1 (n=−1) and indicates a value of the normalized WD at which a diameter of the second near-field light spot 7b becomes minimum depending on the refractive index n of the negative refractive index layer 3 in the information recording medium 24.

The graph in FIG. 6 shows that the greater the refractive index n, the more advantageous since the normalized WD can be increased. However, a study performed by the present inventors has revealed that when the refractive index n is greater than −0.9 (n>−0.9), a partial total reflection occurs and a diameter of the second near-field light spot 7b degrades significantly. For example, the diameter of the second near-field light spot 7b expands by a multiplying factor of several to several ten times. However, it is found that when the refractive index n is equal to or smaller than −0.9 (n≦−0.9), degradation of the diameter of the second near-field light spot 7b can be suppressed by reducing the WD that is an air gap between the near-field light generating element 5 and the information recording medium 24, as the refractive index n of the negative refractive index layer 3 becomes smaller. In this case, for example, the diameter of the second near-field light spot 7b can be kept within a multiplying factor of several times. Therefore, the refractive index n of the negative refractive index layer 3 is favorably kept within a range of −1≦n≦−0.9 to suppress degradation of the diameter of the second near-field light spot 7b and to enable a greater WD. On the other hand, when the refractive index n is smaller than −1.8 (n<−1.8), the normalized WD becomes equal to or shorter than 0.5 and the WD is reduced to half or less. Therefore, the refractive index n of the negative refractive index layer 3 desirably satisfies a range of −1.8≦n≦−0.9.

In addition, when the relative permittivity of the negative refractive index layer 3 exhibits a negative value (favorably, −1) at the wavelength of the recording light or the reproducing light and a thickness of the negative refractive index layer 3 is equal to or less than 1/10 of the wavelength of the recording light or the reproducing light, the relative permeability need not be −1 and a metal film such as Ag, Au, and Cu can also be used as a material of the negative refractive index layer 3. A metal film with Ag as a major component is favorable due to low light loss. However, in this case, since the thickness of the negative refractive index layer 3 is merely equal to or less than 1/10 of the wavelength of the recording light or the reproducing light, a length of the WD is also equal to or shorter than 1/10 of the wavelength of the recording light or the reproducing light. With such a thin layer thickness, since an electrical response and a magnetic response of the material are not coupled, only the permittivity need be considered. Therefore, if the relative permittivity is negative, it can be assumed that a negative refractive index is effectively exhibited.

For example, while optical constants may differ depending on manufacturing methods, when an Ag film is created by vacuum deposition, Ag has a relative permittivity of −1 at an ultraviolet wavelength of around 340 nm. Therefore, the Ag film can be used as the negative refractive index layer 3 having an ideal super lens effect within a range of film thickness. In addition, even if the relative permittivity of the negative refractive index layer 3 deviates from −1 to a certain degree, the negative refractive index layer 3 can be used for recording and reproducing by adjusting the WD.

Furthermore, for example, a film may be produced by creating nanoparticles of a metal such as Ag and by adding an appropriate amount of resin or the like or by self-assembly. By adjusting a mixing ratio or adjusting types of resin so that the relative permittivity approaches −1 in accordance with the wavelength of recording light or reproducing light, the film may be used as the negative refractive index layer 3 having a super lens effect at the wavelength of the recording light or the reproducing light.

Next, recording or reproducing of information according to the present embodiment will be described. As shown in FIG. 4, an optical information recording and reproducing apparatus according to the first embodiment comprises a semiconductor laser light source as the light source 17 for both recording and reproducing, and a collimator lens 20, a beam splitter 18, a mirror 16, an objective lens 15, and the near-field light generating element 5 are arranged on an optical path from the light source 17 to the information recording medium 24. A servo signal detecting optical element 22 and a detection lens 21 are arranged on a return optical path from the beam splitter 18 to photodetectors 19a and 19b. Moreover, light sources with different wavelengths may be separately provided as the recording and reproducing light sources.

During recording, linearly-polarized laser light (recording light) 25 in the Z-axis direction with relatively high power outputted from the light source 17 in the Y-axis direction is converted into approximately parallel light by the collimator lens 20 and is transmitted through the beam splitter 18, and an optical path of the laser light 25 is bent in the Z-axis direction by the mirror 16.

Subsequently, the Y-axis direction linearly-polarized laser light 25 bent in the Z-axis direction is collected on the near-field light generating element 5 by the objective lens 15 having a numerical aperture NA of, for example, 0.85.

As shown in FIG. 3, the near-field light generating element 5 may be formed using, for example, a metal film such as Au or Ag having a pointed triangle-shape on the XY plane which is parallel to the substrate 1. The linearly-polarized laser light in the Y-axis direction is irradiated onto the near-field light generating element 5 to induce a surface plasmon resonance in the metal film to cause the first near-field light spot 7a (hotspot) having a light intensity that is significantly increased compared to an incident light intensity to be generated in a vicinity of a tip of the metal film.

At least a part of the generated near-field light 8 produces a super lens effect in the negative refractive index layer 3 which exhibits a negative refractive index and which is separated from the near-field light generating element 5 by the WD, and is collected on the microparticles 4 in the recording layer 2 as the second near-field light spot 7b that is approximately equal to a hotspot. The microparticles 4 irradiated with the recording light causes a crystalline-to-amorphous or an amorphous-to-crystalline phase change and information is recorded.

Moreover, besides the triangle shape described above, the near-field light generating element 5 may take any overall shape as long as the shape is pointed so as to facilitate a plasmon resonance. In addition, in order to prevent the collected light 6 by the objective lens 15 from becoming propagating light other than the near-field light 8 and from being irradiated onto the information recording medium 24, the near-field light generating element 5 may be a metal plate which has an overall size that is larger than a spot of the collected light 6, the metal plate having a shape including a minute hole which is opened in a part of an interior of the metal plate and a protrusion formed by a pointed part of the hole. In this case, stray light can be reduced to achieve recording and reproducing at an even better SN ratio.

While Au, Ag, and the like have been exemplified as materials of the near-field light generating element 5, materials are not limited thereto and other materials that cause a plasmon resonance with a laser used may be selected in accordance to a wavelength of the laser used.

During reproducing, in the same manner as during recording, linearly-polarized laser light (reproducing light) 25 in the Z-axis direction with low power outputted from the light source 17 is converted into approximately parallel light by the collimator lens 20 and is transmitted through the beam splitter 18, and an optical path of the laser light 25 is bent in the Z-axis direction by the mirror 16.

Subsequently, the laser light 25 bent in the Z-axis direction is collected on the near-field light generating element 5 by the objective lens 15. The near-field light generating element 5 induces a surface plasmon resonance and causes the first near-field light spot 7a (hotspot) to be generated in a vicinity of a tip of the near-field light generating element 5. At least of a part of the generated near-field light 8 produces a super lens effect in the negative refractive index layer 3 which exhibits a negative refractive index and which is separated from the near-field light generating element 5 by the WD, and is irradiated onto the microparticles 4 on which information is recorded in the recording layer 2 as the second near-field light spot 7b.

At least a part of the near-field light 8 reflected by the microparticles 4 turns back in an opposite direction and is collected on the first near-field light spot 7a, is transmitted as reflected light 6 containing recorded information through the objective lens 15, and is deflected in a -Y-axis direction by the mirror 16. An optical axis of the bent reflected light 6 is deflected in a -Z-axis direction by the beam splitter 18 and the reflected light 6 incidents the servo signal detecting optical element 22. The reflected light 6 is branched into at least two light beams by the servo signal detecting optical element 22 and then branched into two types of convergent light 23a and 23b by the detection lens 21.

The convergent light 23a that becomes reproducing signal light incidents the photodetector 19a and the photodetector 19a detects a recorded signal. The convergent light 23b incidents another photodetector 19b and the photodetector 19b detects a servo signal. The servo signal is used for WD control and minute positional control targeting a central position of the microparticles 4.

Moreover, the optical information recording and reproducing apparatus according to the present embodiment comprises a drive unit that integrally moves the near-field light generating element 5 and the objective lens 15 in an optical axis direction. By having the drive unit move the near-field light generating element 5 and the objective lens 15 in the optical axis direction, the working distance that is an interval between the near-field light generating element 5 and the information recording medium 24 is adjusted.

### Second Embodiment

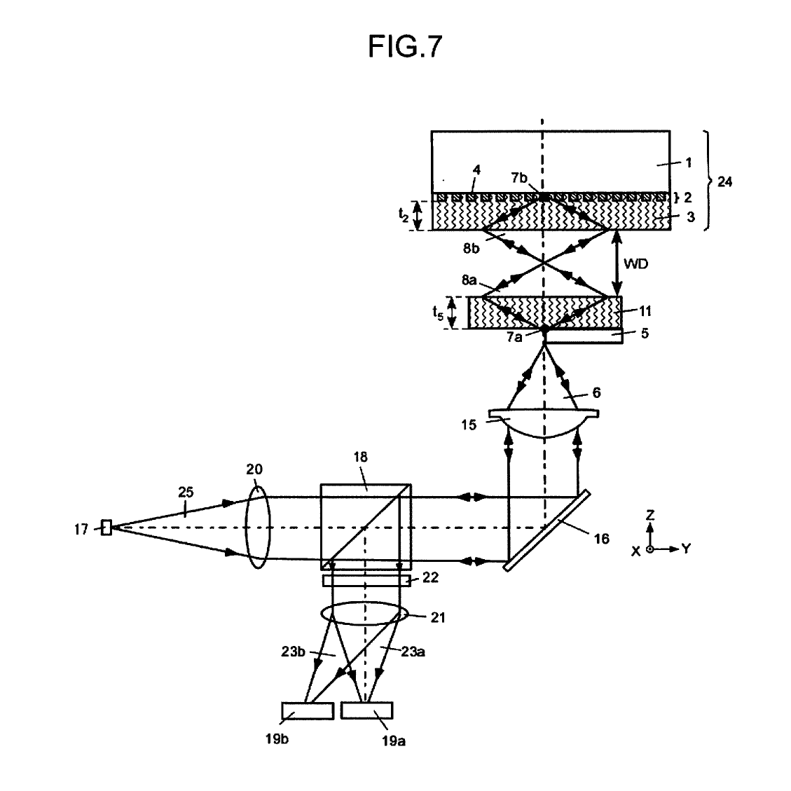

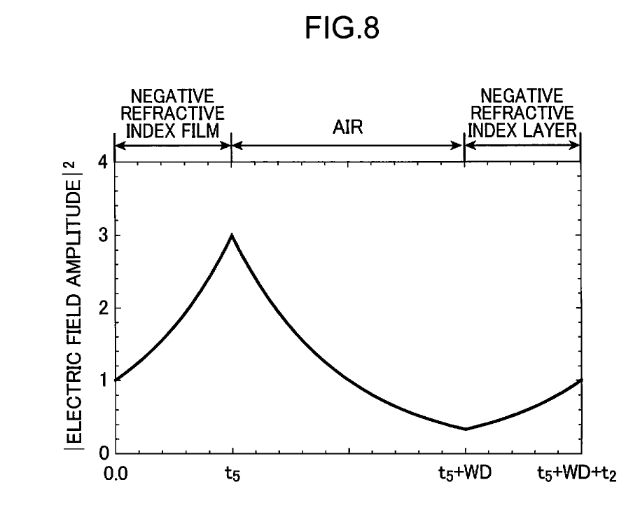

Next, an optical information recording and reproducing apparatus according to a second embodiment of the present invention will be described with reference to FIGS. 7 and 8, focusing on differences from the optical information recording and reproducing apparatus according to the first embodiment. FIG. 7 is an explanatory diagram showing a configuration of an optical information recording and reproducing apparatus, and recording information on or reproducing information from an information recording medium, according to the second embodiment of the present invention, and FIG. 8 is a graph showing a variation in |electric field amplitude|² of near-field light in a Z-axis direction in an optical information recording and reproducing apparatus and an information recording medium according to the second embodiment of the present invention.

The optical information recording and reproducing apparatus according to the second embodiment differs from the optical information recording and reproducing apparatus according to the first embodiment in that a negative refractive index film 11 that effectively exhibits a negative refractive index at a wavelength of recording light or reproducing light is provided on an exit side of a near-field light generating element 5. If a film thickness of the negative refractive index film 11 is denoted by t₅ and a refractive index of the negative refractive index film 11 is −1, then a WD that is an air gap between a negative refractive index layer 3 of an information recording medium 24 and the negative refractive index film 11 is further increased by t₅ and produces an advantageous effect of further reducing a risk of collision or contact. If a layer thickness of the negative refractive index layer 3 is denoted by t₂ and a refractive index of the negative refractive index layer 3 is −1, then the WD may be expressed as t₂+t₅. For example, if t₂=t₅, an advantageous effect is produced in that the WD can be doubled compared to the optical information recording and reproducing apparatus according to the first embodiment.

Another advantageous effect is that the negative refractive index film 11 becomes a protective film of the near-field light generating element 5 and prevents damage when a collision or contact occurs. Since a configuration is adopted in which the negative refractive index layer 3 and the negative refractive index film 11 oppose each other, a lubricating property is improved by using a material with a lubricating property for at least one of the negative refractive index layer 3 and the negative refractive index film 11.

In a similar manner to the negative refractive index layer 3, the negative refractive index film 11 is constituted by at least one of a metamaterial and a photonic crystal.

In addition, in a similar manner to the negative refractive index layer 3, a metal film made of Ag or the like having a negative relative permittivity at a wavelength of recording light or reproducing light can be used as the negative refractive index film 11 when a thickness of the negative refractive index film 11 is equal to or less than 1/10 of the wavelength of the recording light or the reproducing light.

Furthermore, degradation of a diameter of a second near-field light spot 7b can be suppressed by reducing a working distance that is an air gap between the near-field light generating element 5 and the information recording medium 24, as the refractive index of the negative refractive index film 11 becomes smaller.

Even with the optical information recording and reproducing apparatus according to the present embodiment, if the negative refractive index layer 3 and the negative refractive index film 11 effectively exhibit negative refractive indexes, squares of absolute values of an electric field amplitude (|electric field amplitude|²) of a first near-field light spot 7a and the second near-field light spot 7b are equal to or comparable to each other. As shown in FIG. 8, |electric field amplitude|² (in FIG. 8, |electric field amplitude|² of the first near-field light spot 7a has been normalized to 1.0) is exponentially amplified in the negative refractive index film 11 (having a coordinate of 0≦Z≦t₅, where a Z-position of the first near-field light spot 7a is assumed to be 0), attenuates exponentially in air (t₅<Z<t₅+WD), and is once again exponentially amplified in the negative refractive index layer 3 (t₅+WD≦Z≦t₅+WD+t₂). As a result, |electric field amplitude|² at the second near-field light spot 7b (Z=t₅+WD+t₂) has a same value (1.0) as |electric field amplitude|² at the first near-field light spot 7a (Z=0).

In addition, in the same manner as the negative refractive index layer 3, a refractive index n of the negative refractive index film 11 which satisfies −1.8 n≦−0.9 is favorable from a practical perspective since a WD can be secured to a certain degree and degradation of a spot diameter can be suppressed.

Furthermore, the refractive index n of the negative refractive index film 11 more favorably satisfies a range of −1≦n≦−0.9 to suppress degradation of the diameter of the second near-field light spot 7b and to enable a greater WD.

Moreover, the optical information recording and reproducing apparatus according to the present embodiment comprises a drive unit that integrally moves the near-field light generating element 5, the negative refractive index film 11, and the objective lens 15 in an optical axis direction. By having the drive unit move the near-field light generating element 5, the negative refractive index film 11, and the objective lens 15 in the optical axis direction, the working distance that is an interval between the near-field light generating element 5 and the information recording medium 24 is adjusted.

### Third Embodiment

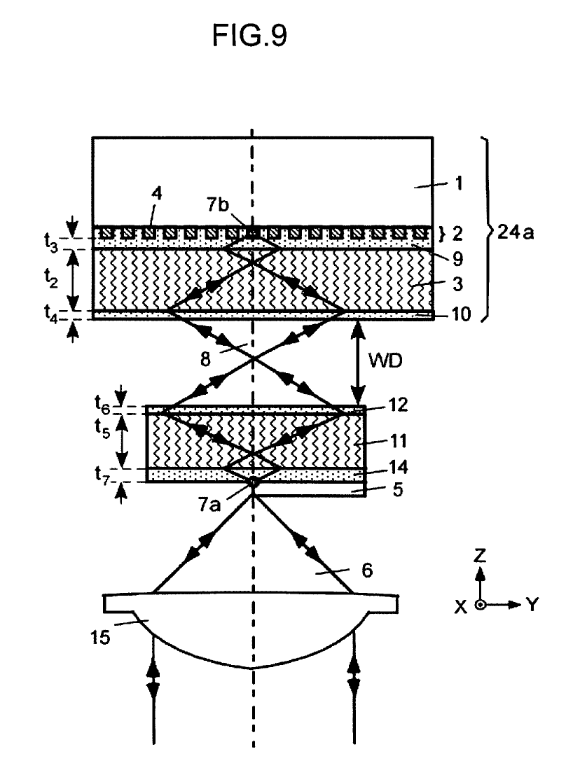

Next, an optical information recording and reproducing apparatus according to a third embodiment of the present invention will be described with reference to FIG. 9, focusing on differences from the information recording medium according to the first embodiment and the optical information recording and reproducing apparatus according to the second embodiment. FIG. 9 is an explanatory diagram showing a part of a configuration of an optical information recording and reproducing apparatus, and recording information on or reproducing information from an information recording medium, according to a third embodiment of the present invention.

An information recording medium 24a according to the third embodiment differs from the information recording medium 24 according to the first embodiment in that the information recording medium 24a at least comprises a dielectric layer 9 provided between a negative refractive index layer 3 and a recording layer 2 and/or a protective layer 10 provided on an incident side of the negative refractive index layer 3. FIG. 9 shows a configuration of the information recording medium 24a comprising both the dielectric layer 9 and the protective layer 10.

In addition, the optical information recording and reproducing apparatus according to the third embodiment differs from the optical information recording and reproducing apparatus according to the second embodiment in that the optical information recording and reproducing apparatus according to the third embodiment at least comprises a dielectric film 14 provided between a negative refractive index film 11 and a near-field light generating element 5 and/or a protective film 12 provided on an exit side of the negative refractive index film 11. FIG. 9 shows a configuration of the optical information recording and reproducing apparatus comprising both the dielectric film 14 and the protective film 12.

Providing the dielectric layer 9 enables the negative refractive index layer 3 and microparticles 4 in the recording layer 2 to be separated from each other and produces an advantageous effect of preventing migration that often occurs during recording when temperatures of the negative refractive index layer 3 and the microparticles 4 rise. This advantageous effect is particularly significant when a major component of the negative refractive index layer 3 is a metal such as Ag. Furthermore, since a structure is realized in which the microparticles 4 are covered by the dielectric layer 9, environmental resistance of the recording layer 2 can be further improved in comparison to a case where the microparticles 4 are only covered by the negative refractive index layer 3. Moreover, by using a thermally-conductive material suitable for recording on the microparticles 4 for the dielectric layer 9, recording sensitivity of the microparticles 4 can be adjusted.

In addition, by providing at least one of or both the protective layer 10 and the protective film 12, even if an optical head and the information recording medium 24a collide with or come into contact with each other, an elastic material such as resin or a material with a favorable lubricating property can be freely used as the protective layer 10 or the protective film 12. Furthermore, even if an optical head and the information recording medium 24a collide with or come into contact with each other, the damage of the collision or contact can be reduced in comparison with a case where only the negative refractive index layer 3 or the negative refractive index film 11 is provided.

Moreover, providing the dielectric film 14 enables the negative refractive index film 11 and the near-field light generating element 5 to be separated from each other and produces an advantageous effect of preventing migration that often occurs during recording when temperatures of the negative refractive index film 11 and the near-field light generating element 5 rise. This advantageous effect is particularly significant when a major component of the negative refractive index film 11 is a metal such as Ag and the near-field light generating element 5 is also constituted by a metal film.

As the dielectric layer 9 and the dielectric film 14, for example, one or a plurality of oxides selected from the following can be used: ZrSiO₄, (ZrO₂)₂₅(SiO₂)₂₅(Cr₂O₃)₅₀, SiCr, TiO₂, ZrO₂, HfO₂, ZnO, Nb₂O₅, Ta₂O₅, SiO₂, SnO₂, Al₂O₃, Bi₂O₃, Cr₂O₃, Ga₂O₃, In₂O₃, Sc₂O₃, Y₂O₃, La₂O₃, Gd₂O₃, Dy₂O₃, Yb₂O₃, CaO, MgO, CeO₂, TeO₂, and the like. In addition, as the dielectric layer 9 and the dielectric film 14, for example, one or a plurality of nitrides selected from the following can be used: C—N, Ti—N, Zr—N, Nb—N, Ta—N, Si—N, Ge—N, Cr—N, Al—N, Ge—Si—N, Ge—Cr—N, and the like. Furthermore, for example, a sulfide such as ZnS, a carbide such as SiC, a fluoride such as LaF₃, CeF₃, and MgF₂, and C can be used as the dielectric layer 9 and the dielectric film 14. Moreover, the dielectric layer 9 and the dielectric film 14 may be formed using a compound comprising one or a plurality of materials selected from the materials listed above.

The dielectric layer 9 and the dielectric film 14 function as insulators that block electricity. The dielectric layer 9 physically and electrically separates the negative refractive index layer 3 and the recording layer 2 from each other, and the dielectric film 14 physically and electrically separates the negative refractive index film 11 and the near-field light generating element 5 from each other. In addition, the protective layer 10 protects the recording layer 2 and the protective film 12 protects the near-field light generating element 5 (near-field light outputting element).

While an inorganic material such as that used for the dielectric layer 9 and the dielectric film 14 may be used as the protective layer 10 and the protective film 12, an organic material such as resin is desirably used because such an organic material is generally capable of reducing an impact caused by a collision. Furthermore, the protective layer 10 and the protective film 12 may be a composite material of an organic material and an inorganic material.

As is apparent from FIG. 9, in the configuration of the optical information recording and reproducing apparatus and the information recording medium according to the present embodiment, an optical path of the near-field light 8 can be given a symmetric structure about an air layer between the first near-field light spot 7a and the second near-field light spot 7b.

In other words, the protective layer 10 and the protective film 12 may be configured using the same material or using materials with comparable refractive indexes and configured so as to have the same or comparable thicknesses, the dielectric layer 9 and the dielectric film 14 may be configured using the same material or using materials with comparable refractive indexes and configured so as to have the same or comparable thicknesses, and the negative refractive index layer 3 and the negative refractive index film 11 may be configured using the same material or using materials with comparable refractive indexes and configured so as to have the same or comparable thicknesses. In this case, the concept of “comparable” includes a margin of error of approximately ±10%.

Accordingly, when viewing the second near-field light spot 7b from the first near-field light spot 7a, the near-field light 8 has a completely symmetrical shape. When the near-field light 8 is completely symmetrical or almost completely symmetrical, even if a member (for example, a protective film, a protective layer, a dielectric film, and a dielectric layer) constituted by a material with a refractive index deviated from 1 such as 1.5 is present in an intermediate optical path of the near-field light 8, a wavefront aberration is cancelled and a degradation of a near-field light spot can be prevented as long as the member is symmetrically arranged via an air layer. In other words, the present inventors have found an advantageous effect in that the first near-field light spot 7a and the second near-field light spot 7b can be readily equalized. That is, the present embodiment has an advantageous effect in that a super lens effect can be easily produced.

Moreover, the optical information recording and reproducing apparatus according to the present embodiment comprises a drive unit that integrally moves the near-field light generating element 5, the negative refractive index film 11, the protective film 12, the dielectric film 14, and the objective lens 15 in an optical axis direction. By having the drive unit move the near-field light generating element 5, the negative refractive index film 11, the protective film 12, the dielectric film 14, and the objective lens 15 in the optical axis direction, the working distance that is an interval between the protective film 12 and the information recording medium 24a is adjusted.

### Fourth Embodiment

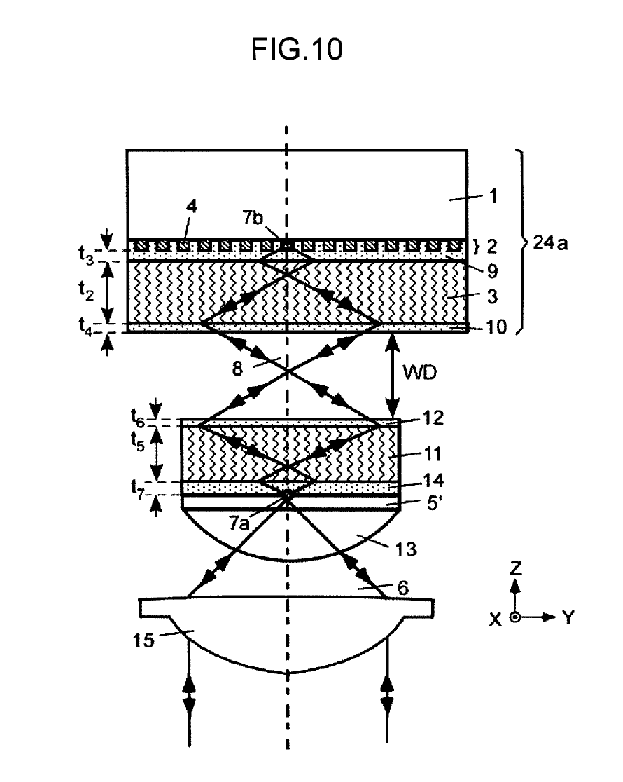

Next, an optical information recording and reproducing apparatus and an information recording medium according to a fourth embodiment of the present invention will be described with reference to FIG. 10, focusing on differences from the information recording medium and the optical information recording and reproducing apparatus according to the third embodiment. FIG. 10 is an explanatory diagram showing a part of a configuration of an optical information recording and reproducing apparatus, and recording information on or reproducing information from an information recording medium, according to the fourth embodiment of the present invention.

While an information recording medium 24a according to the present embodiment shares the same configuration as the information recording medium according to the third embodiment, a configuration of the optical information recording and reproducing apparatus according to the present embodiment differs from that of the optical information recording and reproducing apparatus according to the third embodiment. The configuration differs in that an SIL (solid immersion lens) 13 is provided in an optical path between an objective lens 15 and a near-field light generating element 5′, and recording light or reproducing light is transmitted through the SIL 13 by the objective lens 15 and collected on the near-field light generating element 5′. In addition, an entirety of the near-field light generating element 5′ is arranged larger than a spot of collected light 6. The near-field light generating element 5′ is a metal plate formed elongated in the Y-direction on a flat rear surface (a surface that outputs the recording light or the reproducing light) of the SIL 13, the metal plate having a shape (not shown) including a minute hole which is opened in a part of an interior of the metal plate and a protrusion formed by a pointed part of the hole. Moreover, the near-field light generating element 5′ according to the present embodiment corresponds to an example of a near-field light outputting element.

Due to an effect of the SIL, a collection spot diameter of the collected light 6 collected on the near-field light generating element 5′ on the rear surface of the SIL 13 by the objective lens 15 has an increased numerical aperture NA and, as a result, a smaller spot diameter can be adopted. For example, while the numerical aperture NA is 0.85 with the objective lens 15 alone, the numerical aperture NA increases to 1.7 by providing the SIL 13 which is a twofold improvement in the numerical aperture NA, resulting in a reduction of the collection spot diameter by half and, for example, a fourfold improvement in maximum light intensity. By collecting the collection spot of the SIL 13 on the near-field light generating element 5′, a first near-field light spot 7a is generated. At this point, by collecting light with high light intensity on the near-field light generating element 5′, a plasmon resonance is more likely to occur and, as a result, the intensity of the first near-field light spot 7a increases and enables high-sensitivity recording or reproducing of information.

Furthermore, a gap servo signal can also be formed which controls a WD using a characteristic of an evanescent wave when the WD is large, a reflected light intensity is high in which light that differs from the recording light or the reproducing light and that has an oblique-incidence component incidents a surface of the SIL 13 on which the near-field light generating element 5′ is not formed.

Moreover, the optical information recording and reproducing apparatus according to the present embodiment comprises a drive unit that integrally moves the near-field light generating element 5′, the negative refractive index film 11, the protective film 12, the SIL 13, the dielectric film 14, and the objective lens 15 in an optical axis direction. By having the drive unit move the near-field light generating element 5′, the negative refractive index film 11, the protective film 12, the SIL 13, the dielectric film 14, and the objective lens 15 in the optical axis direction, the working distance that is an interval between the protective film 12 and the information recording medium 24a is adjusted.

### Fifth Embodiment

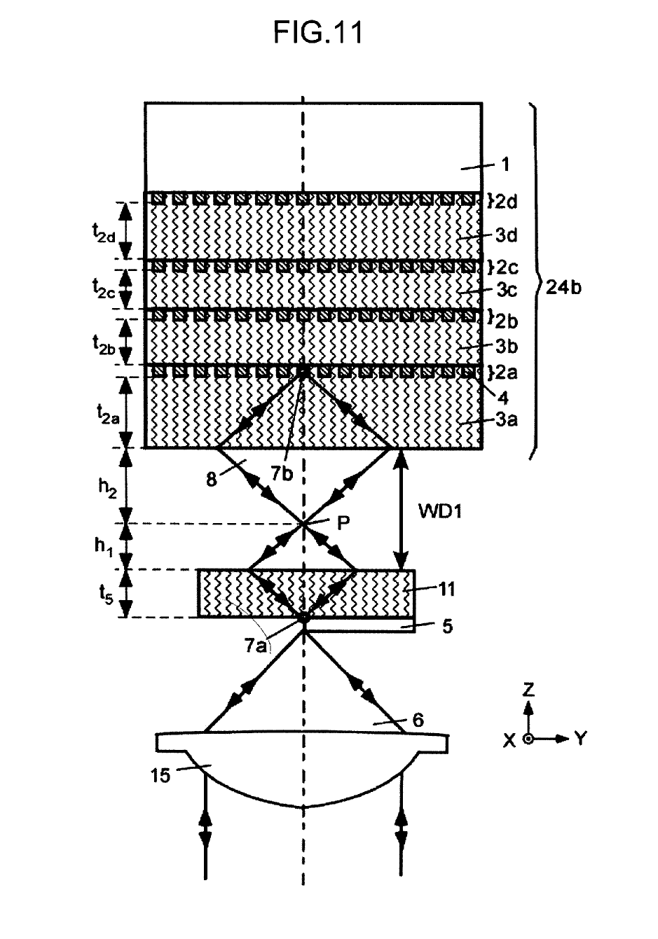

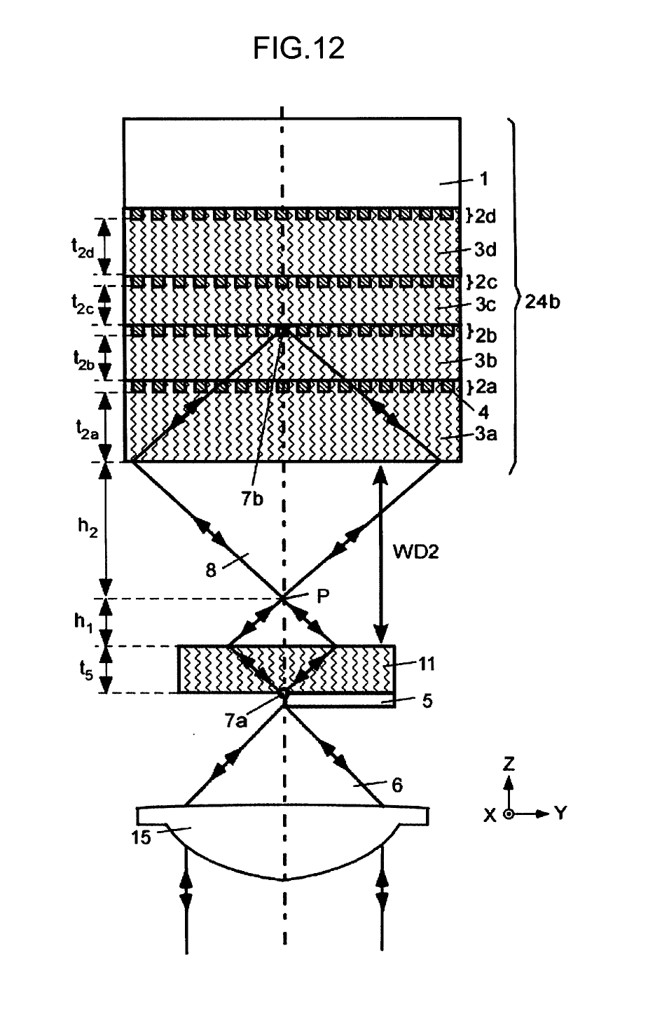

Next, an optical information recording and reproducing apparatus and an information recording medium according to a fifth embodiment of the present invention will be described with reference to FIGS. 11 and 12, focusing on differences from the information recording medium and the optical information recording and reproducing apparatus according to the second embodiment. FIG. 11 is an explanatory diagram showing a part of a configuration of an optical information recording and reproducing apparatus, and recording information on or reproducing information from a recording layer closest to an incident side (first layer) of an information recording medium, according to the fifth embodiment of the present invention, and FIG. 12 is an explanatory diagram showing a part of a configuration of an optical information recording and reproducing apparatus, and recording information on or reproducing information from a second closest recording layer to an incident side (second layer) of an information recording medium, according to the fifth embodiment of the present invention.

An information recording medium 24b according to the present embodiment differs from the information recording medium 24 according to the second embodiment in that the information recording medium 24b is a multilayer information recording medium comprising a plurality of recording layers (first to fourth recording layers 2a to 2d). By replacing a single-layer information recording medium with a multilayer information recording medium, an advantageous effect of increased recording capacity can be achieved. Negative refractive index layers (first to fourth negative refractive index layers 3a to 3d) which effectively exhibit a negative refractive index at a wavelength of recording light or reproducing light are respectively provided between the recording layers as intermediate layers.

In other words, the information recording medium 24b according to the present embodiment at least comprises: a substrate 1; negative refractive index layers 3a to 3d which effectively exhibit a negative refractive index at a wavelength of recording light or reproducing light; and recording layers 2a to 2d, wherein the negative refractive index layers 3a to 3d and the recording layers 2a to 2d are alternately formed in plurality in sequence from an incident side of the recording light or the reproducing light.

FIGS. 11 and 12 show a case where, for example, there are four recording layers. In sequence from an incident side of the recording light or the reproducing light (in FIGS. 11 and 12, an incident side of near-field light 8), the information recording medium 24b comprises a first negative refractive index layer 3a (thickness t₂ₐ), a first recording layer 2a, a second negative refractive index layer 3b (thickness t_{2b}), a second recording layer 2b, a third negative refractive index layer 3c (thickness t_{2c}), a third recording layer 2c, a fourth negative refractive index layer 3d (thickness t_{2d}), a fourth recording layer 2d, and the substrate 1.

Moreover, while four recording layers are provided in the present embodiment, the present invention is not limited thereto and two, three, or five or more recording layers may be provided instead, in which case a negative refractive index layer is provided on a light incident side of each recording layer.

In other words, the information recording medium comprises: a substrate; first to m^{th} (where m is an integer equal to or greater than 1) recording layers respectively provided on an incident side of recording light or reproducing light with respect to the substrate, in order of distance closer to the incident side; and first to m^{th} (where m is an integer equal to or greater than 1) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately provided on the substrate, and the first to m^{th} negative refractive index layers effectively have a negative refractive index at a wavelength of the recording light or the reproducing light.

Moreover, when there is one recording layer (m=1), a configuration of single-layer information recording medium such as those shown in the first to fourth embodiments is adopted.

The optical information recording and reproducing apparatus according to the present invention records or reproduces information using at least any of the plurality of recording layers 2a to 2d (the first recording layer 2a in FIG. 11 and/or the second recording layer 2b in FIG. 12) of the information recording medium 24b. The optical information recording and reproducing apparatus comprises a light source (not shown) that outputs recording light or reproducing light, an objective lens 15, and a near-field light generating element 5. The objective lens 15 collects the recording light or the reproducing light on the near-field light generating element 5. The optical information recording and reproducing apparatus uses at least a part of near-field light 8 generated by the near-field light generating element 5 to record information on any of the first to m^{th} recording layers of the information recording medium 24b or to reproduce information from any of the first to m^{th} recording layers of the information recording medium 24b.

In addition, the optical information recording and reproducing apparatus uses at least a part of the near-field light 8 generated from the near-field light generating element 5 to record or reproduce information by reducing a working distance (WD 1 in FIG. 11 and/or WD2 in FIG. 12) as a target recording layer (the first recording layer 2a in FIG. 11 and/or the second recording layer 2b in FIG. 12) becomes closer to the near-field light generating element 5.

Furthermore, in the same manner as the optical information recording and reproducing apparatus according to the second embodiment, the optical information recording and reproducing apparatus according to the present embodiment further comprises a negative refractive index film 11 which effectively exhibits a negative refractive index at a wavelength of the recording light or the reproducing light and which is provided on an exit side of the near-field light generating element 5. By providing the negative refractive index film 11, the WD can be further increased. Moreover, in the present embodiment, the optical information recording and reproducing apparatus may alternatively be configured not to comprise the negative refractive index film 11 in the same manner as the first embodiment.

When recording information on or reproducing information from the first recording layer 2a as a target layer, as shown in FIG. 11, the working distance WD1 (h₁+h₂ in FIG. 11) is adjusted so that a first near-field light spot (hotspot) 7a generated from the near-field light generating element 5 is collected as a second near-field light spot 7b on microparticles 4 in the first recording layer 2a. For example, when the first negative refractive index layer 3a and the negative refractive index film 11 both have a refractive index of −1, h₁=t₅ and h₂=t₂ₐ, and the working distance WD1 becomes a sum of the thickness t₂ₐ of the first negative refractive index layer 3a and the thickness t₅ of the negative refractive index film 11 (in other words, WD1=t₂ₐ+t₅).

When recording information on or reproducing information from the second recording layer 2b as a target layer, as shown in FIG. 12, the working distance WD2 (h₁+h₂ in FIG. 12) is adjusted so that the first near-field light spot (hotspot) 7a generated from the near-field light generating element 5 is collected as the second near-field light spot 7b on the microparticles 4 in the second recording layer 2b. For example, when the first negative refractive index layer 3a, the second negative refractive index layer 3b, and the negative refractive index film 11 all have a refractive index of −1, h₁=t₅ and h₂≅t₂ₐ+t_{2b}, and the working distance WD2 becomes a sum of the thickness t₂ₐ of the first negative refractive index layer 3a, the thickness t_{2b} of the second negative refractive index layer 3b, and the thickness t₅ of the negative refractive index film 11 (in other words, WD2≅t₂ₐ+t_{2b}+t₅). In this case, all of the recording layers generally have a thickness of a few nm to a few 10 nm and the negative refractive index layers that are intermediate layer have a thickness of a few 100 nm to a few Therefore, an approximation of the expression given above is true at a high precision and WD2=t₂ₐ+t_{2b}+t₅ may be assumed.

When recording information on or reproducing information from the third recording layer 2c as a target layer, in the same manner as described above, a third working distance WD3 is adjusted so that the first near-field light spot (hotspot) 7a generated from the near-field light generating element 5 is collected as the second near-field light spot 7b on the microparticles 4 in the third recording layer 2c. For example, when the first negative refractive index layer 3a, the second negative refractive index layer 3b, the third negative refractive index layer 3c, and the negative refractive index film 11 all have a refractive index of −1, the working distance WD3 becomes a sum of the thickness t₂ₐ of the first negative refractive index layer 3a, the thickness t_{2b} of the second negative refractive index layer 3b, the thickness t_{2c} of the third negative refractive index layer 3c, and the thickness t₅ of the negative refractive index film 11 (in other words, WD3≅t₂ₐ+t_{2b}+t_{2c}+t₅).

In addition, when recording information on or reproducing information from the fourth recording layer 2d as a target layer, in the same manner as described above, a fourth working distance WD4 is adjusted so that the first near-field light spot (hotspot) 7a generated from the near-field light generating element 5 is collected as the second near-field light spot 7b on the microparticles 4 in the fourth recording layer 2d. For example, when the first negative refractive index layer 3a, the second negative refractive index layer 3b, the third negative refractive index layer 3c, the fourth negative refractive index layer 3d, and the negative refractive index film 11 all have a refractive index of −1, the working distance WD4 becomes a sum of the thickness t₂ₐ of the first negative refractive index layer 3a, the thickness t_{2b} of the second negative refractive index layer 3b, the thickness t_{2c} of the third negative refractive index layer 3c, the thickness t_{2d} of the fourth negative refractive index layer 3d, and the thickness t₅ of the negative refractive index film 11 (in other words, WD4=t₂ₐ+t_{2b}+t₂ₐ+t_{2d}+t₅).

Therefore, the WDs when recording information on or reproducing information from the respective recording layers have a relationship expressed as WD1<WD2<WD3<WD4. In the optical information recording and reproducing apparatus according to the present embodiment, information is recorded or reproduced by reducing the working distance as a target recording layer becomes closer to the near-field light generating element 5. In a normal multilayer information recording medium that does not use a negative refractive index layer as an intermediate layer, the WDs may be expressed as WD1>WD2>WD3>WD4. Therefore, with the optical information recording and reproducing apparatus according to the present embodiment, the WD when recording information on or reproducing information from each recording layer can be described as being the exact opposite of a normal multilayer information recording medium. Moreover, as described earlier, the number of the recording layers is not limited to four.

Moreover, the optical information recording and reproducing apparatus according to the present embodiment comprises a drive unit that integrally moves the near-field light generating element 5, the negative refractive index film 11, and the objective lens 15 in an optical axis direction. By having the drive unit move the near-field light generating element 5, the negative refractive index film 11, and the objective lens 15 in the optical axis direction, the working distance that is an interval between the negative refractive index film 11 and the information recording medium 24b is adjusted.

As described above, with the optical information recording and reproducing apparatus according to the present embodiment, information is recorded or reproduced by reducing the working distance as a target recording layer becomes closer to the near-field light generating element 5. Therefore, in a multilayer information recording medium, an influence of stray light from a deep recording layer can be reduced. In other words, the influence of stray light is reduced because a greater WD is secured when performing recording on or reproducing from a deeper recording layer. Consequently, an SN ratio can be increased even when recording information on or reproducing information from a deep recording layer.

An optical information recording and reproducing apparatus method according to the present embodiment records or reproduces information using at least any of the plurality of recording layers 2a to 2d (the first recording layer 2a in FIG. 11 and/or the second recording layer 2b in FIG. 12) of the information recording medium 24b. The optical information recording and reproducing method comprises the steps of: outputting recording light or reproducing light from a light source (not shown); collecting the recording light or the reproducing light on the near-field light generating element 5 with the objective lens 15; outputting the near-field light 8 from the near-field light generating element 5; recording information on any of the first to fourth recording layers 2a to 2d of the information recording medium 24b or reproducing information from any of the first to fourth recording layers 2a to 2d of the information recording medium 24b using at least a part of the near-field light 8 generated from the near-field light generating element 5.

As a target recording layer (the first recording layer 2a in FIG. 11 and/or the second recording layer 2b in FIG. 12) becomes closer to the near-field light generating element 5, the optical information recording and reproducing method reduces a working distance (WD1 in FIG. 11 and/or WD2 in FIG. 12) to record or reproduce information. The optical information recording and reproducing method enables selection of a recording layer to become a target layer among the multilayer information recording medium 24b and enables information to be recorded or reproduced at a high sensitivity and a high density using near-field light.

### Sixth Embodiment

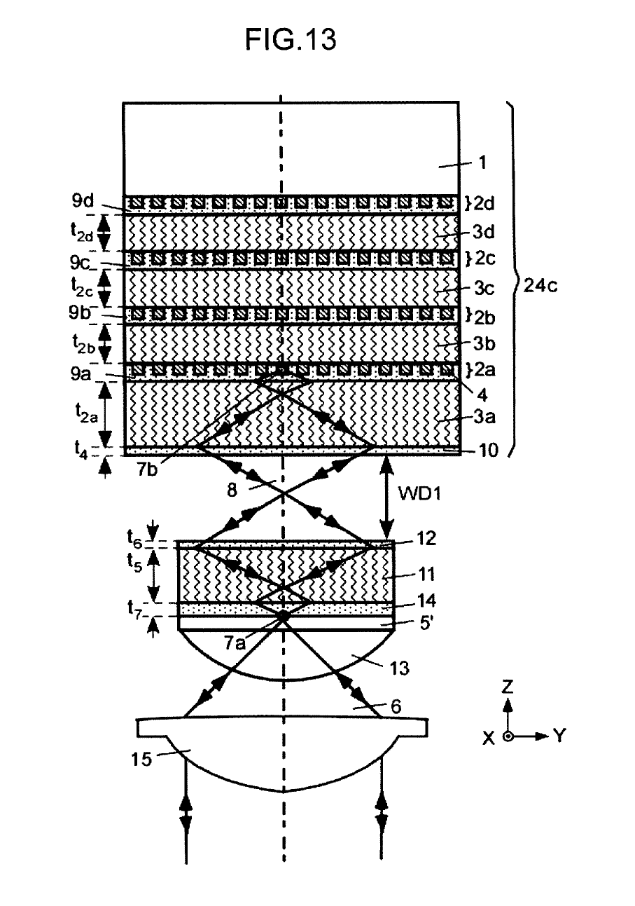

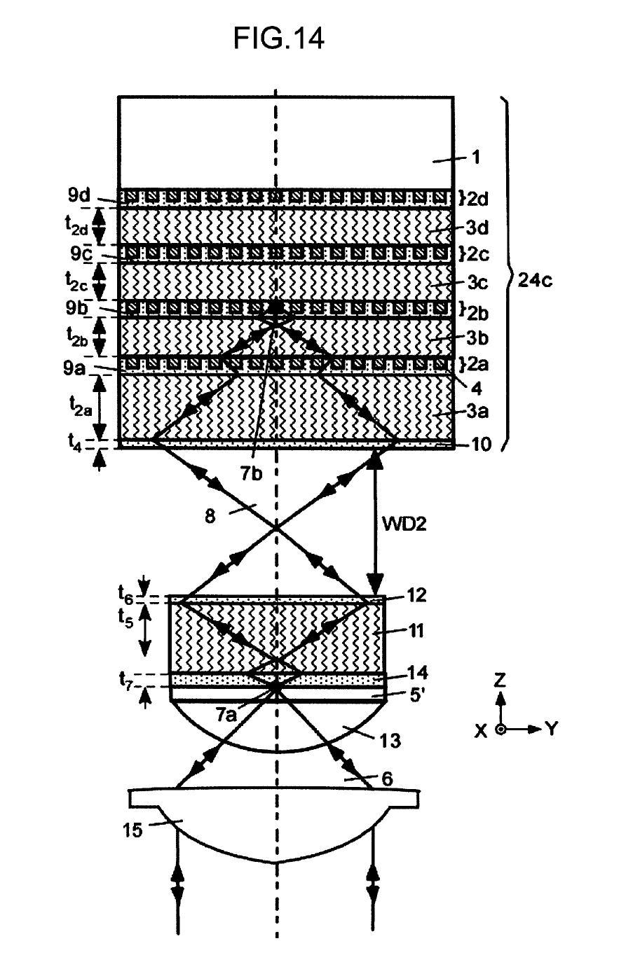

Next, an optical information recording and reproducing apparatus and an information recording medium according to a sixth embodiment of the present invention will be described with reference to FIGS. 13 and 14, focusing on differences from the information recording medium according to the fifth embodiment and the optical information recording and reproducing apparatus according to the fourth embodiment. FIG. 13 is an explanatory diagram showing a part of a configuration of an optical information recording and reproducing apparatus, and recording information on or reproducing information from a recording layer closest to an incident side (first layer) of an information recording medium, according to the sixth embodiment of the present invention, and FIG. 14 is an explanatory diagram showing a part of a configuration of an optical information recording and reproducing apparatus, and recording information on or reproducing information from a second closest recording layer to an incident side (second layer) of an information recording medium, according to the sixth embodiment of the present invention.

While an information recording medium 24c according to the present embodiment is also a multilayer information recording medium comprising a plurality of recording layers 2a to 2d, a difference from the information recording medium 24b according to the fifth embodiment is that the information recording medium 24c according to the present embodiment comprises first to fourth dielectric layers 9a to 9d provided between first to fourth negative refractive index layers 3a to 3d that are intermediate layers and first to fourth recording layers 2a to 2d, and a protective layer 10 provided on an incident side of the first negative refractive index layer 3a.

While the optical information recording and reproducing apparatus according to the present embodiment shares the same configuration as the optical information recording and reproducing apparatus according to the fourth embodiment, a difference is that the optical information recording and reproducing apparatus according to the present embodiment uses at least a part of near-field light 8 generated from a near-field light generating element 5′ to record or reproduce information by reducing a working distance (WD 1 in FIG. 13 and/or WD2 in FIG. 14) as a target recording layer (the first recording layer 2a in FIG. 13 and/or the second recording layer 2b in FIG. 14) becomes closer to the near-field light generating element 5.

FIGS. 13 and 14 show a case where, for example, there are four recording layers. In sequence from an incident side of recording light or reproducing light (in FIGS. 13 and 14, an incident side of the near-field light 8), the information recording medium 24c comprises a protective layer 10 (thickness t₄), a first negative refractive index layer 3a (thickness t₂ₐ), a first dielectric layer 9a, a first recording layer 2a, a second negative refractive index layer 3b (thickness t_{2b}), a second dielectric layer 9b, a second recording layer 2b, a third negative refractive index layer 3c (thickness t_{2c}), a third dielectric layer 9c, a third recording layer 2c, a fourth negative refractive index layer 3d (thickness t_{2d}), a fourth dielectric layer 9d, a fourth recording layer 2d, and the substrate 1.

Moreover, while four recording layers are provided in the present embodiment, the present invention is not limited thereto and two, three, or five or more recording layers may be provided instead, in which case a dielectric layer and a negative refractive index layer are respectively provided on a light incident side of each recording layer and a protective layer is provided on a light incident side of the first negative refractive index layer 3a.

Providing the first to fourth dielectric layers 9a to 9d between the first to fourth negative refractive index layers 3a to 3d and the first to fourth recording layers 2a to 2d enables the first to fourth negative refractive index layers 3a to 3d and microparticles 4 in the first to fourth recording layers 2a to 2d to be separated from each other and produces an advantageous effect of preventing migration that often occurs during recording when temperatures of the first to fourth negative refractive index layers 3a to 3d and the microparticles 4 rise. This advantageous effect is particularly significant when a major component of the first to fourth negative refractive index layers 3a to 3d is a metal such as Ag. Furthermore, since a structure is realized in which the microparticles 4 are covered by the first to fourth dielectric layers 9a to 9d, environmental resistance of the first to fourth recording layers 2a to 2d can be further improved in comparison to a case where the microparticles 4 are only covered by the first to fourth negative refractive index layers 3a to 3d. Moreover, by using a thermally-conductive material suitable for recording on the microparticles 4 for the first to fourth dielectric layers 9a to 9d, recording sensitivity of the microparticles 4 can be adjusted.

As shown in FIGS. 13 and 14, while the first to fourth dielectric layers 9a to 9d are desirably provided between all of the first to fourth negative refractive index layers 3a to 3d and the first to fourth recording layers 2a to 2d, alternatively, a dielectric layer may be provided between at least any of the first to fourth negative refractive index layers 3a to 3d and the first to fourth recording layers 2a to 2d.

In addition, by providing the protective layer 10 or the protective film 12, even if the optical information recording and reproducing apparatus that is an optical head and the information recording medium 24c collide with or come into contact with each other, an elastic material such as resin or a material with a favorable lubricating property can be freely used as the protective layer 10 or the protective film 12. Furthermore, even if the optical head and the information recording medium 24c collide with or come into contact with each other, a damage caused by the collision or the contact can be reduced in comparison to a case where only the negative refractive index layer 3a or the negative refractive index film 11 is provided.

Since the optical information recording and reproducing apparatus according to the sixth embodiment of the present invention comprises the protective layer 10, the protective film 12, and the first to fourth dielectric layers 9a to 9d, as shown in FIGS. 13 and 14, in principle, a WD is reduced compared to the optical information recording and reproducing apparatus according to the fifth embodiment. However, if the thickness of the first to fourth negative refractive index layers 3a to 3d and the negative refractive index film 11 is significantly greater (for example, equal to or greater than a few 100 nm) than the thickness of the protective layer 10, the protective film 12, and the first to fourth dielectric layers 9a to 9d (for example, a few 10 nm), the WD of the optical information recording and reproducing apparatus according to the present sixth embodiment becomes similar to the WD of the optical information recording and reproducing apparatus according to the fifth embodiment.

Moreover, the optical information recording and reproducing apparatus according to the present embodiment comprises a drive unit that integrally moves the near-field light generating element 5′, the negative refractive index film 11, the protective film 12, the SIL 13, the dielectric film 14, and the objective lens 15 in an optical axis direction. By having the drive unit move the near-field light generating element 5′, the negative refractive index film 11, the protective film 12, the SIL 13, the dielectric film 14, and the objective lens 15 in the optical axis direction, the working distance that is an interval between the protective film 12 and the information recording medium 24c is adjusted.

### Seventh Embodiment

Next, an information recording medium according to a seventh embodiment of the present invention will be described by focusing on differences from the information recording medium according to the fifth and sixth embodiments.

While an information recording medium 24d according to the present embodiment is also a multilayer information recording medium comprising a plurality of recording layers, the information recording medium 24d according to the present embodiment differs from the information recording mediums 24b and 24c according to the fifth and sixth embodiments in that refractive indexes of the respective negative refractive index layers are not uniform.

The information recording medium 24d according to the present embodiment is, for example, a multilayer information recording medium which is similar to the information recording mediums 24b and 24c according to the fifth and sixth embodiments and in which a first negative refractive index layer 3a closest to an incident side of recording light or reproducing light has a refractive index of −0.9 and other refractive index layers 3b, 3c, and 3d have a refractive index of −1.

Moreover, the information recording medium 24d according to the present embodiment is not limited to this example, and comprises: a substrate; first to m^{th} (where m is an integer equal to or greater than 2) recording layers respectively provided on an incident side of recording light or reproducing light with respect to the substrate, in order of distance closer to the incident side; and first to m^{th} (where m is an integer equal to or greater than 2) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately provided on the substrate, and the negative refractive index layers effectively have a negative refractive index at a wavelength of the recording light or the reproducing light. In addition, a refractive index nⱼ (2≦j≦m) of the second to m^{th} negative refractive index layers satisfies a range of −1≦nⱼ<−0.9, and a refractive index n₁ of the first negative refractive index layer that is closest to the incident side of the recording light or the reproducing light satisfies a range of nⱼ<n₁≦−0.9.

As described above, the optical information recording and reproducing apparatus uses at least a part of near-field light 8 generated from a near-field light generating element 5 to record or reproduce information by reducing a working distance (for example, WD 1 in FIG. 11 and WD2 in FIG. 12) as a target recording layer (for example, the first recording layer 2a in FIG. 11 and/or the second recording layer 2b in FIG. 12) becomes closer to the near-field light generating element 5. In other words, for the second to fourth recording layers 2b to 2d other than the first recording layer 2a closest to the incident side of the recording light or the reproducing light, a working distance can be secured that is further increased by an amount corresponding to a layer thickness of the second to fourth negative refractive index layers 3b to 3d which are provided closer to the incident side of the recording light or the reproducing light than the second to fourth recording layers 2b to 2d. However, for the first recording layer 2a that is closest to the incident side of the recording light or the reproducing light, only the first negative refractive index layer 3a is provided on the incident light side. Therefore, when recording information on or reproducing information from the first recording layer 2a, the working distance is smaller than in a case of recording information on or reproducing information from the second to fourth recording layers 2b to 2d other than the first recording layer 2a.

Consequently, as is the case with the information recording medium 24d according to the present seventh embodiment, a configuration is adopted in which the refractive index nₙ (2≦j≦m) of the second to m^{th} negative refractive index layers satisfies a range of −1≦nⱼ<−0.9, and the refractive index n₁ of the first negative refractive index layer that is closest to the incident side of the recording light or the reproducing light satisfies a range of nⱼ<n₁≦−0.9 or, in other words, the refractive index n₁ of the first negative refractive index layer that is closest to the incident side of the recording light or the reproducing light is set greater than the refractive index nⱼ of the second to m^{th} negative refractive index layers (where n₁≦−0.9). Accordingly, a greater working distance can be secured even when recording information on or reproducing information from the first recording layer 2a that is closest to the incident side of the recording light or the reproducing light, and the risk of the near-field light generating element 5 and the information recording medium 24d colliding with or coming into contact with each other can be further reduced.

### Eighth Embodiment

Next, a manufacturing method of an information recording medium according to an eighth embodiment of the present invention will be described.

A manufacturing method of an information recording medium according to the present embodiment comprises the steps of: forming first to m^{th} (where m is an integer equal to or greater than 1) recording layers respectively provided on an incident side of recording light or reproducing light with respect to the substrate, in order of distance closer to the incident side; forming first to m^{th} (where m is an integer equal to or greater than 1) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately formed on the substrate.

Moreover, when there is one recording layer (m=1), a single-layer information recording medium such as those shown in the first to fourth embodiments is manufactured. In addition, when there are four recording layers (m=4), a multilayer information recording medium such as those shown in the fifth and sixth embodiments is manufactured. The number of recording layers is not limited to one (m=1) and four (m=4).

Furthermore, the manufacturing method of an information recording medium may comprise a step of forming at least one dielectric layer between an i^{th} negative refractive index layer and an i^{th} recording layer. Moreover, the manufacturing method of an information recording medium may comprise a step of forming a protective layer on the first negative refractive index layer on an incident side of recording light or reproducing light.

Furthermore, the negative refractive index layer may be formed by a film that includes at least one of a metamaterial or a photonic crystal. Alternatively, the negative refractive index layer may be formed by a metal film that exhibits a negative relative permittivity at a wavelength of the recording light or the reproducing light, and a thickness of the metal film is favorably equal to or less than 1/10 of the wavelength of the recording light or the reproducing light.

### Ninth Embodiment

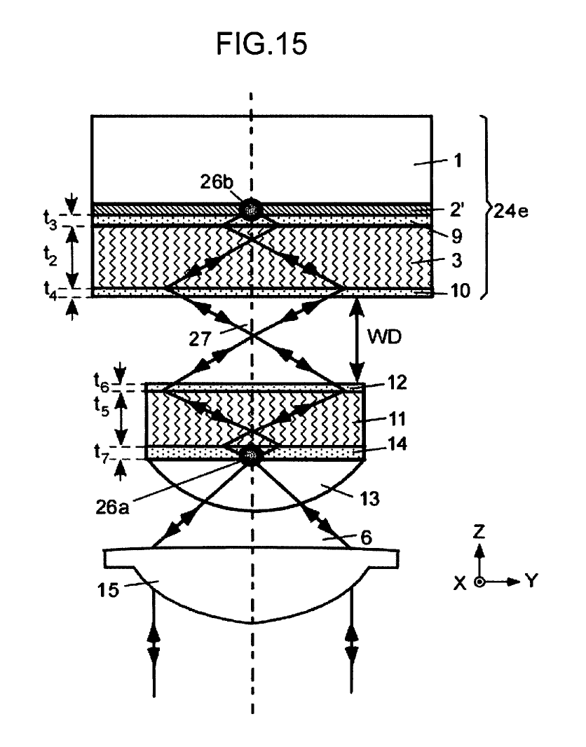

Next, an optical information recording and reproducing apparatus and an information recording medium according to a ninth embodiment of the present invention will be described with reference to FIG. 15, focusing on differences from the information recording medium and the optical information recording and reproducing apparatus according to the third embodiment. FIG. 15 is an explanatory diagram showing a part of a configuration of an optical information recording and reproducing apparatus, and recording information on or reproducing information from an information recording medium, according to the ninth embodiment of the present invention.

An information recording medium 24e according to the ninth embodiment differs from the information recording medium 24a according to the third embodiment in that the information recording medium 24e according to the ninth embodiment comprises a recording layer 2′ which is formed by a phase-change recording material and which has a film geometry with a uniform thickness in place of the recording layer 2 constituted by a plurality of microparticles 4 arranged in an island pattern. In FIG. 15, the information recording medium 24e comprises a substrate 1, the recording layer 2′, a dielectric layer 9, a negative refractive index layer 3, and a protective layer 10.

In addition, the optical information recording and reproducing apparatus according to the ninth embodiment differs from the optical information recording and reproducing apparatus according to the second embodiment in that the optical information recording and reproducing apparatus according to the ninth embodiment comprises an SIL 13 in place of the near-field light generating element 5. In FIG. 15, the optical information recording and reproducing apparatus at least comprises the SIL 13, a dielectric film 14, a negative refractive index film 11, and a protective film 12. Moreover, the SIL 13 according to the present embodiment corresponds to an example of a near-field light outputting element.

Since other components of the information recording medium 24e and the optical information recording and reproducing apparatus according to the ninth embodiment are the same as the other components of the information recording medium 24a and the optical information recording and reproducing apparatus according to the third embodiment, a description thereof will be omitted.

Linearly-polarized laser light 25 in the Y-axis direction is collected on the SIL 13 by an objective lens 15 having a numerical aperture NA of, for example, 0.85. As shown in FIG. 15, the SIL 13 has a semispherical shape and laser light incidents from a convex surface side. The SIL 13 outputs near-field light 27 having an enhanced numerical aperture NA and which includes propagating light, and causes a first collection spot 26a to be generated at an outputting portion of the SIL 13.

At least a part of the generated near-field light 27 including propagating light is transmitted through the dielectric film 14, the negative refractive index film 11, and the protective film 12, and incidents the protective layer 10 that is separated from the protective film 12 by a WD. At least the part of the near-field light 27 which includes propagating light and which has been transmitted through the protective layer 10, the negative refractive index layer 3, and the dielectric layer 9 is collected on the recording layer 2′ as a second collection spot 26b approximately equal to the first collection spot 26a. The recording layer 2′ irradiated with the recording light causes a crystalline-to-amorphous or an amorphous-to-crystalline phase change and information is recorded.

As is apparent from FIG. 15, in the configuration of the optical information recording and reproducing apparatus and the information recording medium according to the present embodiment, an optical path of the near-field light 27 including propagating light can be given a symmetric structure about an air layer between the first collection spot 26a and the second collection spot 26b.

In other words, the protective layer 10 and the protective film 12 may be configured using the same material or using materials with comparable refractive indexes and configured so as to have the same or comparable thicknesses, the dielectric layer 9 and the dielectric film 14 may be configured using the same material or using materials with comparable refractive indexes and configured so as to have the same or comparable thicknesses, and the negative refractive index layer 3 and the negative refractive index film 11 may be configured using the same material or using materials with comparable refractive indexes and configured so as to have the same or comparable thicknesses. In this case, the concept of “comparable” includes a margin of error of approximately ±10%.

Accordingly, when viewing the second collection spot 26b from the first collection spot 26a, the near-field light 27 including propagating light has a completely symmetrical shape. When the near-field light 27 including propagating light is completely symmetrical or almost completely symmetrical, even if a member (for example, a protective film, a protective layer, a dielectric film, and a dielectric layer) constituted by a material with a refractive index deviated from 1 such as 1.5 is present in an intermediate optical path of the near-field light 27 including propagating light, a wavefront aberration is cancelled and a degradation of a collection spot can be prevented as long as the member is symmetrically arranged via an air layer. In other words, the present inventors have found an advantageous effect in that the first collection spot 26a and the second collection spot 26b can be readily equalized. That is, the present embodiment has an advantageous effect in that a super lens effect can be easily produced.

Moreover, in the present embodiment, the information recording medium 24e may be configured without the dielectric layer 9 and the protective layer 10, and the optical information recording and reproducing apparatus may be configured without the negative refractive index film 11, the protective film 12, and the dielectric film 14. In this case, the information recording medium 24e comprises the substrate 1, the recording layer 2′, and the negative refractive index layer 3, and the optical information recording and reproducing apparatus comprises the SIL 13 and the objective lens 15.

Furthermore, in the present embodiment, the information recording medium 24e may be configured without the dielectric layer 9 and the protective layer 10, and the optical information recording and reproducing apparatus may be configured without the protective film 12 and the dielectric film 14. In this case, the information recording medium 24e comprises the substrate 1, the recording layer 2′, and the negative refractive index layer 3, and the optical information recording and reproducing apparatus comprises the negative refractive index film 11, the SIL 13 and the objective lens 15.

### Tenth Embodiment

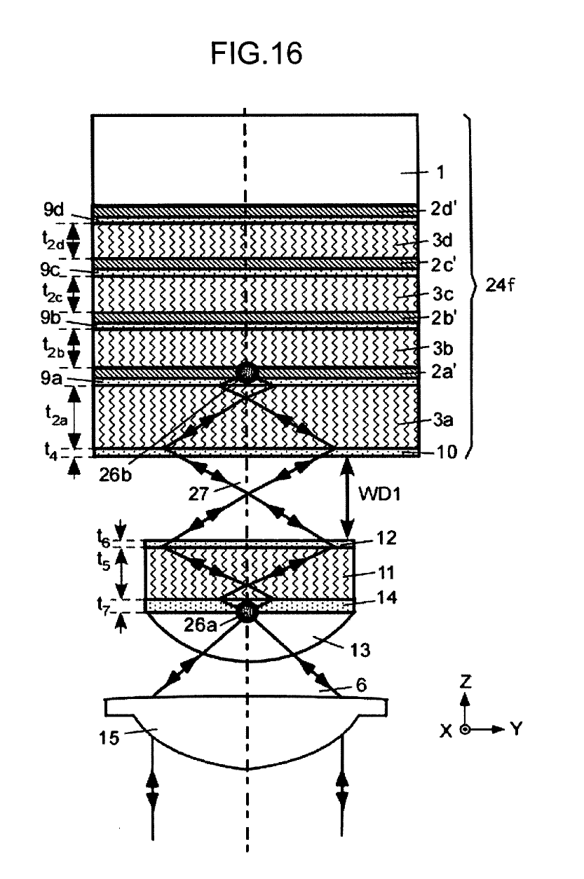

Next, an optical information recording and reproducing apparatus and an information recording medium according to a tenth embodiment of the present invention will be described with reference to FIG. 16, focusing on differences from the information recording medium and the optical information recording and reproducing apparatus according to the sixth embodiment. FIG. 16 is an explanatory diagram showing a part of a configuration of an optical information recording and reproducing apparatus, and recording information on or reproducing information from a recording layer closest to an incident side (first layer) of an information recording medium, according to the tenth embodiment of the present invention.

An information recording medium 24f according to the tenth embodiment differs from the information recording medium 24c according to the sixth embodiment in that the information recording medium 24f according to the tenth embodiment comprises first to fourth recording layers 2a′ to 2d′ which are formed by a phase-change recording material and which have a film geometry with a uniform thickness in place of the first to fourth recording layers 2a to 2d which are constituted by a plurality of microparticles 4 arranged in an island pattern. In FIG. 16, the information recording medium 24f comprises a protective layer 10 (thickness t₁), a first negative refractive index layer 3a (thickness t₂ₐ), a first dielectric layer 9a, a first recording layer 2a′, a second negative refractive index layer 3b (thickness t_{2b}), a second dielectric layer 9b, a second recording layer 2W, a third negative refractive index layer 3c (thickness t_{2c}), a third dielectric layer 9c, a third recording layer 2c′, a fourth negative refractive index layer 3d (thickness t_{2d}), a fourth dielectric layer 9d, a fourth recording layer 2d′, and the substrate 1.

Moreover, while four recording layers are provided in the present embodiment, the present invention is not limited thereto and two, three, or five or more recording layers may be provided instead, in which case a dielectric layer and a negative refractive index layer are respectively provided on a light incident side of each recording layer and a protective layer is provided on a light incident side of the first negative refractive index layer 3a.

In addition, the optical information recording and reproducing apparatus according to the tenth embodiment differs from the optical information recording and reproducing apparatus according to the sixth embodiment in that the optical information recording and reproducing apparatus according to the tenth embodiment comprises an SIL 13 in place of the near-field light generating element 5′. In FIG. 16, the optical information recording and reproducing apparatus at least comprises the SIL 13, a dielectric film 14, a negative refractive index film 11, and a protective film 12. Moreover, the SIL 13 according to the present embodiment corresponds to an example of a near-field light outputting element.

Since other components of the information recording medium 24f and the optical information recording and reproducing apparatus according to the tenth embodiment are the same as the other components of the information recording medium 24c and the optical information recording and reproducing apparatus according to the sixth embodiment, a description thereof will be omitted. In addition, the configuration of the optical information recording and reproducing apparatus according to the tenth embodiment is the same as the configuration of the optical information recording and reproducing apparatus according to the ninth embodiment.

Linearly-polarized laser light 25 in the Y-axis direction is collected on the SIL 13 by an objective lens 15 having a numerical aperture NA of, for example, 0.85. As shown in FIG. 16, the SIL 13 has a semispherical shape and laser light incidents from a convex surface side. The SIL 13 outputs near-field light 27 having an enhanced numerical aperture NA and which includes propagating light, and causes a first collection spot 26a to be generated at an outputting portion of the SIL 13.

At least a part of the generated near-field light 27 including propagating light is transmitted through the dielectric film 14, the negative refractive index film 11, and the protective film 12, and incidents the protective layer 10 that is separated from the protective film 12 by a WD. At least the part of the near-field light 27 which includes propagating light and which has been transmitted through the protective layer 10, the negative refractive index layer 3, and the dielectric layer 9 is collected on the first recording layer 2a′ as a second collection spot 26b approximately equal to the first collection spot 26a. The first recording layer 2a′ irradiated with the recording light causes a crystalline-to-amorphous or an amorphous-to-crystalline phase change and information is recorded.

Moreover, while FIG. 16 illustrates an example in which information is recorded on or reproduced from the first recording layer 2a′, recording of information on or reproducing of information from another recording layer is performed in the same manner as the other embodiments.

As is apparent from FIG. 16, in the configuration of the optical information recording and reproducing apparatus and the information recording medium according to the present embodiment, an optical path of the near-field light 27 including propagating light can be given a symmetric structure about an air layer between the first collection spot 26a and the second collection spot 26b.

In other words, the protective layer 10 and the protective film 12 may be configured using the same material or using materials with comparable refractive indexes and configured so as to have the same or comparable thicknesses, the dielectric layer 9 and the dielectric film 14 may be configured using the same material or using materials with comparable refractive indexes and configured so as to have the same or comparable thicknesses, and the negative refractive index layer 3 and the negative refractive index film 11 may be configured using the same material or using materials with comparable refractive indexes and configured so as to have the same or comparable thicknesses. In this case, the concept of “comparable” includes a margin of error of approximately ±10%.

Accordingly, when viewing the second collection spot 26b from the first collection spot 26a, the near-field light 27 including propagating light has a completely symmetrical shape. When the near-field light 27 including propagating light is completely symmetrical or almost completely symmetrical, even if a member (for example, a protective film, a protective layer, a dielectric film, and a dielectric layer) constituted by a material with a refractive index deviated from 1 such as 1.5 is present in an intermediate optical path of the near-field light 27 including propagating light, a wavefront aberration is cancelled and a degradation of a collection spot can be prevented as long as the member is symmetrically arranged via an air layer. In other words, the present inventors have found an advantageous effect in that the first collection spot 26a and the second collection spot 26b can be readily equalized. That is, the present embodiment has an advantageous effect in that a super lens effect can be easily produced.

Moreover, in the present embodiment, the information recording medium 24f may be configured without the first to fourth dielectric layers 9a to 9d and the protective layer 10, and the optical information recording and reproducing apparatus may be configured without the negative refractive index film 11, the protective film 12 and the dielectric film 14. In this case, the information recording medium 24f comprises the substrate 1, the first to fourth recording layers 2a′ to 2d′, and the first to fourth negative refractive index layers 3a to 3d, and the optical information recording and reproducing apparatus comprises the SIL 13 and the objective lens 15.

Furthermore, in the present embodiment, the information recording medium 24f may be configured without the first to fourth dielectric layers 9a to 9d and the protective layer 10, and the optical information recording and reproducing apparatus may be configured without the protective film 12 and the dielectric film 14. In this case, the information recording medium 24f comprises the substrate 1, the first to fourth recording layers 2a′ to 2d′, and the first to fourth negative refractive index layers 3a to 3d, and the optical information recording and reproducing apparatus comprises the negative refractive index film 11, the SIL 13, and the objective lens 15.

While information recording mediums, optical information recording and reproducing apparatuses, optical information recording and reproducing methods, and manufacturing methods of the information recording mediums according to the first to tenth embodiments have been heretofore described, the present invention is not limited to these embodiments. Information recording mediums, optical information recording and reproducing apparatuses, optical information recording and reproducing methods, and manufacturing methods of the information recording mediums which combine configurations of the information recording mediums, the optical information recording and reproducing apparatuses, the optical information recording and reproducing methods, and the manufacturing methods of the information recording mediums according to the respective embodiments are also included in the present invention and achieve similar advantageous effects.

The objective lens, the collimator lens, and the detection lens used in the embodiments described above have been denominated for the sake of convenience and are all ordinary lenses.

Furthermore, while an optical disc has been described as an example of an information recording medium in the embodiments above, applications to a card-like product, a drum-like product, or a tape-like product designed to enable an optical information recording and reproducing apparatus similar to those of the embodiments above to reproduce information recording mediums of a plurality of different specifications including thickness and recording density are also included in the scope of the present invention.

Moreover, the specific embodiments described above mainly comprise inventions configured as described below.

An information recording medium according to an aspect of the present invention comprises: a substrate; first to m^{th} (where m is an integer equal to or greater than 1) recording layers respectively provided on an incident side of recording light or reproducing light with respect to the substrate, in order of distance closer to the incident side; and first to m^{th} (where m is an integer equal to or greater than 1) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately provided on the substrate, and the first to m^{th} negative refractive index layers effectively have a negative refractive index at a wavelength of the recording light or the reproducing light.

According to this configuration, a structure is realized in which a recording layer formed on a substrate is covered by a negative refractive index layer, and the negative refractive index layer protects the recording layer to enable damage to the recording layer to be reduced even if an information recording medium and an optical head collide with or come into contact with each other and to enable environmental resistance of the recording layer to be improved. As a result, a highly-reliable information recording medium can be realized.

In addition, the negative refractive index layer can create a near-field light spot, which has a light intensity and a spot diameter that are more or less comparable to those of a near-field light spot as a hotspot generated in a vicinity of a near-field light outputting element, on the recording layer while securing, to a certain extent, a working distance that is an interval between the optical head and a surface of the information recording medium. Therefore, the near-field light spot on the recording layer has a sensitivity and a resolution comparable to a case where recording or reproducing is performed by a hotspot, and enables information to be recorded or reproduced at a high density and a high sensitivity.

Furthermore, in the information recording medium described above, favorably, a refractive index n of at least one negative refractive index layer among the first to m^{th} negative refractive index layers satisfies a range of −1.8≦n≦−0.9.

According to this configuration, by having a refractive index n of at least one negative refractive index layer among the first to m^{th} negative refractive index layers satisfy a range of −1.8≦n≦−0.9, degradation of recording light or reproducing light can be suppressed and a sufficient working distance can be secured.

Furthermore, in the information recording medium described above, favorably, a refractive index n of at least one negative refractive index layer among the first to m^{th} negative refractive index layers satisfies a range of −1.8≦n≦−0.9.

According to this configuration, by having a refractive index n of at least one negative refractive index layer among the first to m^{th} negative refractive index layers satisfy a range of −1.8≦n≦−0.9, degradation of recording light or reproducing light can be suppressed and a greater working distance can be secured.

Moreover, in the information recording medium described above, favorably, a refractive index nⱼ (2≦j≦m) of the second to m^{th} (where m is an integer equal to or greater than 2) negative refractive index layers satisfies a range of −1≦nⱼ<−0.9, and a refractive index n₁ of the first negative refractive index layer that is closest to the incident side of the recording light or the reproducing light satisfies a range of nⱼ<n₁≦−0.9.

According to this configuration, even when recording information on or reproducing information from the first recording layer that is closest to the incident side of the recording light or the reproducing light, a greater working distance can be secured and a collision or contact between an optical head and the information recording medium can be further reduced.

In addition, in the information recording medium described above, favorably, at least one negative refractive index film layer among the first to m^{th} negative refractive index layers is a film that includes at least one of a metamaterial and a photonic crystal.

According to this configuration, at least one negative refractive index film layer among the first to m^{th} negative refractive index layers can be fabricated by a film that includes at least one of a metamaterial and a photonic crystal.

Furthermore, in the information recording medium described above, favorably, at least one negative refractive index film layer among the first to m^{th} negative refractive index layers includes a metal film that exhibits a negative relative permittivity at a wavelength of the recording light or the reproducing light, and a thickness of at least one negative refractive index film layer among the first to m^{th} negative refractive index layers is equal to or less than 1/10 of the wavelength of the recording light or the reproducing light.

According to this configuration, since the thickness of at least one negative refractive index film layer among the first to m^{th} negative refractive index layers is equal to or less than 1/10 of the wavelength of the recording light or the reproducing light, a length of a working distance can also be set equal to or shorter than 1/10 of the wavelength of the recording light or the reproducing light.

Moreover, favorably, the information recording medium described above further at least comprises one dielectric layer provided between the i^{th} negative refractive index layer and the i^{th} recording layer.

According to this configuration, since at least one dielectric layer is provided between the i^{th} negative refractive index layer and the i^{th} recording layer, the negative refractive index layer and the recording layer are separated from each other and a migration that often occurs during recording when temperatures of the negative refractive index layer and the recording layer rise can be prevented. Furthermore, since a structure is realized in which the recording layer is covered by the dielectric layer, environmental resistance of the recording layer can be further improved in comparison to a case where the recording layer is only covered by the negative refractive index layer. Moreover, by using a thermally-conductive material suitable for recording on the recording layer for the dielectric layer, recording sensitivity of the recording layer can be adjusted.

In addition, favorably, the information recording medium described above further comprises a protective layer provided on the first negative refractive index layer on an incident side of the recording light or the reproducing light. According to this configuration, since a protective layer is provided on the first negative refractive index layer on an incident side of the recording light or the reproducing light, even if an optical head and the information recording medium collide with or come into contact with each other, damage to the recording layer can be reduced in comparison to a case where only the first negative refractive index layer is provided.

Furthermore, in the information recording medium described above, favorably, the recording layers each include microparticles which are arranged in an island pattern and which have an optical constant that is variable in accordance with the recording light, wherein a size of the microparticles in an array direction is equal to or smaller than 30 nm. According to this configuration, since the microparticles are separated from each other, high-density recording or reproducing with a light spot equal to or smaller than 30 nm can be performed while avoiding the influence of thermal diffusion during recording.

Moreover, in the information recording medium described above, favorably, a major component of the microparticles is a phase-change recording material. According to this configuration, since a major component of the microparticles is a phase-change recording material, rewritable recording can be performed in which information can be recorded or reproduced with high quality and in which information can be erased.

In addition, in the information recording medium described above, favorably, the recording light or the reproducing light includes near-field light. According to this configuration, by recording information on or reproducing information from a recording layer using at least a part of near-field light having a high resolution, information can be recorded or reproduced at high density.

An optical information recording and reproducing apparatus according to another aspect of the present invention is an optical information recording and reproducing apparatus that records information on an information recording medium or reproduces information from the information recording medium, the information recording medium comprising: a substrate; first to m^{th} (where m is an integer equal to or greater than 1) recording layers respectively provided on an incident side of recording light or reproducing light with respect to the substrate, in order of distance closer to the incident side; and first to m^{th} (where m is an integer equal to or greater than 1) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately provided on the substrate, and the first to m^{th} negative refractive index layers effectively have a negative refractive index at a wavelength of the recording light or the reproducing light, the optical information recording and reproducing apparatus comprising: a light source that outputs the recording light or the reproducing light; a near-field light outputting element that outputs near-field light; and an objective lens that collects the recording light or the reproducing light on the near-field light outputting element, wherein the optical information recording and reproducing apparatus records information on any of the first to m^{th} recording layers of the information recording medium or reproduces information from any of the first to m^{th} recording layers of the information recording medium using at least a part of the near-field light outputted from the near-field light outputting element.

According to this configuration, the negative refractive index layer can create a near-field light spot, which has a light intensity and a spot diameter that are more or less comparable to those of a near-field light spot as a hotspot generated in a vicinity of a near-field light outputting element, on the recording layer while securing, to a certain extent, a working distance that is an interval between an optical head and a surface of the information recording medium. Therefore, the near-field light spot on the recording layer has a sensitivity and a resolution comparable to a case where recording or reproducing is performed by a hotspot, and enables information to be recorded or reproduced at a high density and a high sensitivity.

In addition, in the optical information recording and reproducing apparatus described above, favorably, information is recorded or reproduced by reducing a working distance that is an interval between the near-field light outputting element and a surface of the information recording medium, as a target recording layer among the first to m^{th} recording layers becomes closer to the near-field light outputting element.

According to this configuration, since information is recorded or reproduced by reducing a working distance that is an interval between the near-field light outputting element and a surface of the information recording medium as a target recording layer among the first to m^{th} recording layers becomes closer to the near-field light outputting element, an influence of stray light from a deep recording layer can be reduced in a multilayer information recording medium. In other words, when recording information on or reproducing information from a deep recording layer, since a longer working distance is secured in comparison to a case where information is recorded on or reproduced from a nearer recording layer, the influence of stray light is reduced. Consequently, an SN ratio can be increased even when recording information on or reproducing information from a deep recording layer.

Furthermore, in the optical information recording and reproducing apparatus described above, favorably, a refractive index n of at least one negative refractive index layer among the first to m^{th} negative refractive index layers satisfies a range of −1.8≦n≦−0.9.

According to this configuration, by having a refractive index n of at least one negative refractive index layer among the first to m^{th} negative refractive index layers satisfy a range of −1.8≦n≦−0.9, degradation of recording light or reproducing light can be suppressed and a sufficient working distance can be secured.

Moreover, in the optical information recording and reproducing apparatus described above, favorably, a refractive index n of at least one negative refractive index layer among the first to m^{th} negative refractive index layers satisfies a range of −1≦n≦−0.9.

According to this configuration, by having a refractive index n of at least one negative refractive index layer among the first to m^{th} negative refractive index layers satisfy a range of −1≦n≦−0.9, degradation of recording light or reproducing light can be suppressed and a greater working distance can be secured.

In addition, in the optical information recording and reproducing apparatus described above, favorably, a refractive index n₁ (2≦j≦m) of the second to m^{th} (where m is an integer equal to or greater than 2) negative refractive index layers satisfies a range of −1≦nₙ<−0.9, and a refractive index n₁ of the first negative refractive index layer that is closest to the incident side of the recording light or the reproducing light satisfies a range of nⱼ<n₁≦−0.9.

According to this configuration, even when recording information on or reproducing information from the first recording layer that is closest to the incident side of the recording light or the reproducing light, an even greater working distance can be secured and a collision or contact between an optical head and the information recording medium can be further reduced.

Furthermore, in the optical information recording and reproducing apparatus described above, favorably, information is recorded or reproduced by reducing a working distance that is an interval between the near-field light outputting element and a surface of the information recording medium, as the refractive index of the first to m^{th} negative refractive index layers becomes smaller.

According to this configuration, since information is recorded or reproduced by reducing a working distance that is an interval between the near-field light outputting element and a surface of the information recording medium as the refractive index of the first to m^{th} negative refractive index layers becomes smaller, degradation of a diameter of a near-field light spot can be suppressed.

Moreover, favorably, the optical information recording and reproducing apparatus described above further comprises a negative refractive index film which is provided on the near-field light outputting element on an exit side of the recording light or the reproducing light, and which effectively has a negative refractive index at a wavelength of the recording light or the reproducing light.

According to this configuration, since a working distance between the negative refractive index layer of the information recording medium and the negative refractive index film can be increased by a length corresponding to a film thickness of the negative refractive index film, a collision or contact between the information recording medium and an optical head can be further reduced. In addition, the negative refractive index film can protect the near-field light outputting element and prevent damage to the near-field light outputting element when the information recording medium and the near-field light outputting element collide with or come into contact with each other.

Furthermore, in the optical information recording and reproducing apparatus described above, favorably, a refractive index and a thickness of the negative refractive index film are identical to at least a refractive index and a thickness of the first negative refractive index layer.

According to this configuration, since an optical path of near-field light from a near-field light spot in the near-field light outputting element to a near-field light spot in the recording layer becomes completely symmetrical, a sensitivity and a resolution of the near-field light spot in the near-field light outputting element can be equalized with a sensitivity and a resolution of the near-field light spot in the recording layer. The term “the same” as used herein is not limited to a case where the refractive index and the thickness of the negative refractive index film are consistent with at least the refractive index and the thickness of the first to m^{th} negative refractive index layers, and also includes a case in which there is a margin of error of, for example, approximately ±10%.

In addition, in the optical information recording and reproducing apparatus described above, favorably, the near-field light outputting element includes a solid immersion lens. According to this configuration, near-field light including propagating light can be outputted using the solid immersion lens.

Furthermore, in the optical information recording and reproducing apparatus described above, favorably, the near-field light outputting element includes a near-field light generating element that generates near-field light. According to this configuration, near-field light can be outputted using the near-field light generating element.

Furthermore, favorably, the optical information recording and reproducing apparatus described above further comprises a solid immersion lens provided in an optical path between the objective lens and the near-field light generating element, wherein the objective lens causes the recording light or the reproducing light to be transmitted through the solid immersion lens and collects the recording light or the reproducing light on the near-field light generating element.

According to this configuration, since the solid immersion lens is provided in the optical path between the optical lens and the near-field light generating element, a numerical aperture of collected light transmitted through the solid immersion lens and collected on the near-field light generating element increases due to an effect of the solid immersion lens and, as a result, a spot diameter of the collected light can be further reduced.

Moreover, in the optical information recording and reproducing apparatus described above, favorably, the near-field light generating element is formed on a surface of the solid immersion lens from which the recording light or the reproducing light is outputted.

According to this configuration, since the near-field light generating element is formed on a surface of the solid immersion lens from which the recording light or the reproducing light is outputted, the optical information recording and reproducing apparatus can be downsized.

In addition, favorably, the optical information recording and reproducing apparatus described above further comprises a dielectric film provided between the negative refractive index film and the near-field light outputting element, and a protective film provided on the dielectric film on an exit side of the recording light or the reproducing light.

According to this configuration, since the dielectric film is provided between the negative refractive index film and the near-field light outputting element, a structure is realized in which the near-field light outputting element is covered by the dielectric film. As a result, environmental resistance of the near-field light outputting element can be further improved in comparison to a case where the near-field light outputting element is only covered by the negative refractive index film. In addition, since the protective film is provided on the dielectric film on an exit side of the recording light or the reproducing light, even if an optical head and the information recording medium collide with or come into contact with each other, damage to the near-field light outputting element can be further reduced in comparison to a case where only the negative refractive index film is provided.

Furthermore, in the optical information recording and reproducing apparatus described above, favorably, information is recorded or reproduced by reducing a working distance that is an interval between the near-field light outputting element and the information recording medium, as the refractive index of the negative refractive index film becomes smaller.

According to this configuration, since information is recorded or reproduced by reducing a working distance that is an interval between the near-field light outputting element and the information recording medium as the refractive index of the negative refractive index film becomes smaller, degradation of a spot diameter of near-field light in the recording layer can be suppressed.

Moreover, in the optical information recording and reproducing apparatus described above, favorably, a refractive index n of the negative refractive index film satisfies a range of −1.8≦n≦−0.9. According to this configuration, by having a refractive index n of the negative refractive index film satisfy a range of −1.8≦n≦−0.9, degradation of recording light or reproducing light can be suppressed and a greater working distance can be secured.

An optical information recording and reproducing method according to another aspect of the present invention is an optical information recording and reproducing method of recording information on an information recording medium or reproducing information from the information recording medium, the information recording medium comprising: a substrate; first to m^{th} (where m is an integer equal to or greater than 1) recording layers respectively provided on an incident side of recording light or reproducing light with respect to the substrate, in order of distance closer to the incident side; and first to m^{th} (where m is an integer equal to or greater than 1) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately provided on the substrate, and the first to m^{th} negative refractive index layers effectively have a negative refractive index at a wavelength of the recording light or the reproducing light, and the optical information recording and reproducing method comprising the steps of: outputting the recording light or the reproducing light from a light source; outputting near-field light from a near-field light outputting element; collecting the recording light or the reproducing light on the near-field light outputting element with an objective lens; and recording information on any of the first to m^{th} recording layers of the information recording medium or reproducing information from any of the first to m^{th} recording layers of the information recording medium using at least a part of the near-field light outputted from the near-field light outputting element.

According to this configuration, the negative refractive index layer can create a near-field light spot, which has a light intensity and a spot diameter that are more or less comparable to those of a near-field light spot as a hotspot generated in a vicinity of a near-field light outputting element, on the recording layer while securing, to a certain extent, a working distance that is an interval between an optical head and a surface of the information recording medium. Therefore, the near-field light spot on the recording layer has a sensitivity and a resolution comparable to a case where recording or reproducing is performed by a hotspot, and enables information to be recorded or reproduced at a high density and a high sensitivity.

A manufacturing method of an information recording medium according to another aspect of the present invention is a manufacturing method of an information recording medium comprising the steps of: forming first to m^{th} (where m is an integer equal to or greater than 1) recording layers respectively provided on an incident side of recording light or reproducing light with respect to a substrate, in order of distance closer to the incident side; and forming first to m^{th} (where m is an integer equal to or greater than 1) negative refractive index layers respectively provided on the incident side of the recording light or the reproducing light with respect to the m^{th} recording layer, in order of distance closer to the incident side, wherein an i^{th} (1≦i≦m) recording layer and an i^{th} negative refractive index layer are alternately formed on the substrate, and the first to m^{th} negative refractive index layers effectively have a negative refractive index at a wavelength of the recording light or the reproducing light.

According to this configuration, a structure is realized in which a recording layer formed on a substrate is covered by a negative refractive index layer, and the negative refractive index layer protects the recording layer to enable damage to the recording layer to be reduced even if an information recording medium and an optical head collide with or come into contact with each other and to enable environmental resistance of the recording layer to be improved. As a result, a highly-reliable information recording medium can be realized.

The specific embodiments or examples described in the section titled Description of Embodiments are only intended to clarify the technical contents of the present invention. As such, the present invention should not be narrowly interpreted as being limited to such specific examples as various modifications may be made without departing from the spirit and scope of the present invention.

### INDUSTRIAL APPLICABILITY

The information recording medium, the optical information recording and reproducing apparatus, the optical information recording and reproducing method, and the manufacturing method of an information recording medium according to the present invention enable recording or reproducing of information to be performed with a high sensitivity and a high density while securing a certain amount of a WD in order to prevent an optical head and the information recording medium from colliding with or coming into contact with each other, and also enable highly-reliable utilization of the information recording medium, the optical information recording and reproducing apparatus, the optical information recording and reproducing method, and the manufacturing method of an information recording medium.

1. An information recording medium comprising:
a substrate;
first to m^{th} (where m is an integer equal to or greater than 1) recording layers respectively provided on an incident side of recording light or reproducing light with respect to the substrate, in order of distance closer to the incident side; and
first to m^{th} (where m is an integer equal to or greater than 1) negative refractive index layers respectively provided on the incident side of the recording light or the reproducing light with respect to the m^{th} recording layer, in order of distance closer to the incident side, wherein
an i^{th} (1≦i≦m) recording layer and an i^{th} negative refractive index layer are alternately provided on the substrate, and
the first to m^{th} negative refractive index layers effectively have a negative refractive index at a wavelength of the recording light or the reproducing light.

2. The information recording medium according to claim 1, wherein a refractive index n of at least one negative refractive index layer among the first to m^{th} negative refractive index layers satisfies a range of −1.8≦n≦−0.9.

3. The information recording medium according to claim 1, wherein a refractive index n of at least one negative refractive index layer among the first to m^{th} negative refractive index layers satisfies a range of −1≦n≦−0.9.

4. The information recording medium according to claim 1, wherein
a refractive index nⱼ (2≦j≦m) of the second to m^{th} (where m is an integer equal to or greater than 2) negative refractive index layers satisfies a range of −1≦nⱼ<−0.9, and
a refractive index n₁ of the first negative refractive index layer that is closest to the incident side of the recording light or the reproducing light satisfies a range of nⱼ<n₁≦−0.9.

5. The information recording medium according to claim 1, wherein at least one negative refractive index layer among the first to m^{th} negative refractive index layers is a film that includes at least one of a metamaterial and a photonic crystal.

6. The information recording medium according to claim 1, wherein
at least one negative refractive index layer among the first to m^{th} negative refractive index layers includes a metal film that exhibits a negative relative permittivity at a wavelength of the recording light or the reproducing light, and
a thickness of at least one negative refractive index layer among the first to m^{th} negative refractive index layers is equal to or less than 1/10 of the wavelength of the recording light or the reproducing light.

7. The information recording medium according to claim 1, further comprising at least one dielectric layer provided between the i^{th} negative refractive index layer and the i^{th} recording layer.

8. The information recording medium according to claim 1, further comprising a protective layer provided on the first negative refractive index layer on an incident side of the recording light or the reproducing light.

9. The information recording medium according to claim 1, wherein
the recording layers each include microparticles which are arranged in an island pattern and which have an optical constant that is variable in accordance with the recording light, and
a size of the microparticles in an array direction is equal to or smaller than 30 nm.

10. The information recording medium according to claim 9, wherein a major component of the microparticles is a phase-change recording material.

11. The information recording medium according to claim 1, wherein the recording light or the reproducing light includes near-field light.

12. An optical information recording and reproducing apparatus that records information on an information recording medium or reproduces information from the information recording medium,
the information recording medium including:
a substrate;
first to m^{th} (where m is an integer equal to or greater than 1) recording layers respectively provided on an incident side of recording light or reproducing light with respect to the substrate, in order of distance closer to the incident side; and
first to m^{th} (where m is an integer equal to or greater than 1) negative refractive index layers respectively provided on the incident side of the recording light or the reproducing light with respect to the m^{th} recording layer, in order of distance closer to the incident side,
an i^{th} (1≦i≦m) recording layer and an i^{th} negative refractive index layer being alternately provided on the substrate, and
the first to m^{th} negative refractive index layers effectively having a negative refractive index at a wavelength of the recording light or the reproducing light,
the optical information recording and reproducing apparatus comprising:
a light source that outputs the recording light or the reproducing light;
a near-field light outputting element that outputs near-field light; and
an objective lens that collects the recording light or the reproducing light on the near-field light outputting element, wherein
the optical information recording and reproducing apparatus records information on any of the first to m^{th} recording layers of the information recording medium or reproduces information from any of the first to m^{th} recording layers of the information recording medium using at least a part of the near-field light outputted from the near-field light outputting element.

13. The optical information recording and reproducing apparatus according to claim 12, wherein information is recorded or reproduced by reducing a working distance that is an interval between the near-field light outputting element and a surface of the information recording medium, as a target recording layer among the first to m^{th} recording layers becomes closer to the near-field light outputting element.

14. The optical information recording and reproducing apparatus according to claim 12, wherein a refractive index n of at least one negative refractive index layer among the first to m^{th} negative refractive index layers satisfies a range of −1.8≦n≦−0.9.

15. The optical information recording and reproducing apparatus according to claim 12, wherein a refractive index n of at least one negative refractive index layer among the first to m^{th} negative refractive index layers satisfies a range of −1≦n≦−0.9.

16. The optical information recording and reproducing apparatus according to claim 12, wherein
a refractive index nⱼ (2≦j≦m) of the second to m^{th} (where m is an integer equal to or greater than 2) negative refractive index layers satisfies a range of −1≦nⱼ<−0.9, and
a refractive index n₁ of the first negative refractive index layer that is closest to the incident side of the recording light or the reproducing light satisfies a range of nⱼ<n₁≦−0.9.

17. The optical information recording and reproducing apparatus according to claim 12, wherein information is recorded or reproduced by reducing a working distance that is an interval between the near-field light outputting element and a surface of the information recording medium, as the refractive index of the first to m^{th} negative refractive index layers becomes smaller.

18. The optical information recording and reproducing apparatus according to claim 12, further comprising a negative refractive index film which is provided on the near-field light outputting element on an exit side of the recording light or the reproducing light, and which effectively has a negative refractive index at a wavelength of the recording light or the reproducing light.

19. The optical information recording and reproducing apparatus according to claim 18, wherein a refractive index and a thickness of the negative refractive index film are identical to at least a refractive index and a thickness of the first negative refractive index layer.

20. The optical information recording and reproducing apparatus according to claim 12, wherein the near-field light outputting element includes a solid immersion lens.

21. The optical information recording and reproducing apparatus according to claim 12, wherein the near-field light outputting element includes a near-field light generating element that generates near-field light.

22. The optical information recording and reproducing apparatus according to claim 21, further comprising
a solid immersion lens provided in an optical path between the objective lens and the near-field light generating element, wherein
the objective lens causes the recording light or the reproducing light to be transmitted through the solid immersion lens and collects the recording light or the reproducing light on the near-field light generating element.

23. The optical information recording and reproducing apparatus according to claim 22, wherein the near-field light generating element is formed on a surface of the solid immersion lens from which the recording light or the reproducing light is outputted.

24. The optical information recording and reproducing apparatus according to claim 18, further comprising:
a dielectric film provided between the negative refractive index film and the near-field light outputting element; and
a protective film provided on the dielectric film on an exit side of the recording light or the reproducing light.

25. The optical information recording and reproducing apparatus according to claim 18, wherein information is recorded or reproduced by reducing a working distance that is an interval between the near-field light outputting element and the information recording medium, as the refractive index of the negative refractive index film becomes smaller.

26. The optical information recording and reproducing apparatus according to claim 18, wherein a refractive index n of the negative refractive index film satisfies a range of −1.8≦n≦−0.9.

27. An optical information recording and reproducing method of recording information on an information recording medium or reproducing information from the information recording medium,
the information recording medium including:
a substrate;
first to m^{th} (where m is an integer equal to or greater than 1) recording layers respectively provided on an incident side of recording light or reproducing light with respect to the substrate, in order of distance closer to the incident side; and
first to m^{th} (where m is an integer equal to or greater than 1) negative refractive index layers respectively provided on the incident side of the recording light or the reproducing light with respect to the m^{th} recording layer, in order of distance closer to the incident side,
an i^{th} (1≦i≦m) recording layer and an i^{th} negative refractive index layer being alternately provided on the substrate, and
the first to m^{th} negative refractive index layers effectively having a negative refractive index at a wavelength of the recording light or the reproducing light,
the optical information recording and reproducing method comprising the steps of:
outputting the recording light or the reproducing light from a light source;
outputting near-field light from a near-field light outputting element;
collecting the recording light or the reproducing light on the near-field light outputting element with an objective lens; and
recording information on any of the first to m^{th} recording layers of the information recording medium or reproducing information from any of the first to m^{th} recording layers of the information recording medium using at least a part of the near-field light outputted from the near-field light outputting element.

28. A manufacturing method of an information recording medium comprising the steps of:
forming first to m^{th} (where m is an integer equal to or greater than 1) recording layers respectively provided on an incident side of recording light or reproducing light with respect to a substrate, in order of distance closer to the incident side; and
forming first to m^{th} (where m is an integer equal to or greater than 1) negative refractive index layers respectively provided on the incident side of the recording light or the reproducing light with respect to the m^{th} recording layer, in order of distance closer to the incident side, wherein
an i^{th} (1≦i≦m) recording layer and an i^{th} negative refractive index layer are alternately formed on the substrate, and
the first to m^{th} negative refractive index layers effectively have a negative refractive index at a wavelength of the recording light or the reproducing light.
